(19) United States
(12) Patent Application Publication
(10) Pub. No.: US 2007/0226623 A1
(43) Pub. Date: Sep. 27, 2007

(54) Information reproducing apparatus and information reproducing method

(75) Inventor: Yuuichi Togashi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/723,667

(22) Filed: Mar. 21, 2007

(30) Foreign Application Priority Data
Mar. 24, 2006 (JP) 2006-082059

(51) Int. Cl. G11B 7/00

(52) U.S. Cl. 715/716; 369/44.28

(57) ABSTRACT

In an embodiment of the invention, the use of system parameters can be controlled according to the type of disc, thereby realizing a suitable operation. The embodiment includes means for changing the setting of a reproducing section according to output setting information, when any one of aspect, resolution, and audio used as the output setting information has been changed in the middle of reproducing a first content of the disc, and means for reproducing an object in the second content from an object starting position, when any one of aspect, resolution, and audio used as the output setting information has been changed in the middle of reproducing a second content of the disc.

### CROSS-REFERENCE TO RELATED APPLICATIONS

This application is based upon and claims the benefit of priority from Japanese Patent Application No. 2006-082059, filed Mar. 24, 2006, the entire contents of which are incorporated herein by reference.

### BACKGROUND

1. Field

One embodiment of the invention relates to an information reproducing apparatus and an information reproducing method, more particularly to improvements in an information reproducing apparatus and an information reproducing method which manage the change of the setting of aspect, resolution, audio output, or the like.

2. Description of the Related Art

In recent years, Digital Versatile Discs (DVDs) and their reproducing units have been widely used. Moreover, a High-Definition DVD (a High-Density DVD) which can perform high-density recording and high-quality recording has been developed. This type of reproducing apparatus has been disclosed in Jpn. Pat. Appln. KOKAI Publication No. 11-196412.

The reproducing apparatus can deal with a plurality of types of discs and has the function of determining which type of disc has been installed and displaying the result of the determination. This enables the user to check the disc without effort, which helps improve the operationality.

Generally, the disc reproducing apparatus is provided with a setting managing function of managing the change of the aspect, resolution, and the like.

While the player is reproducing a video signal and outputting the reproduced signal to the display unit, when the user supplies an operation input for changing the aspect or the resolution to the player, the player then changes the aspect or the resolution.

If the player changes the aspect or resolution according to the operation input, while playing back a specific disc, anything bad may happen.

In an advanced content player and a method of playing back advanced contents according to the invention, contents, programs, or applications can be taken in from the outside. The data from the outside is combined with the data recorded on the disc. The combined data is reproduced and output. Moreover, the reproducing route is changed according to the user operation. Therefore, if the aspect or resolution is changed during the reproduction, the changed aspect or resolution may not agree with the present reproducing operation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary diagrams to help explain the configuration of standard contents and that of advanced contents;

FIGS. 2A to 2C are exemplary diagrams to help explain a category-1 disc, a category-2 disc, and a category-3 disc, respectively;

FIG. 3 is an exemplary diagram to help explain an example of referring to an enhanced video object (EVOB) according to time map information (TMAPI);

FIG. 4 is an exemplary diagram to help explain an example of a volume space in a disc according to the invention;

FIG. 5 is an exemplary diagram to help explain an example of directories and files in a disc according to the invention;

FIG. 6 is an exemplary diagram showing the configuration of management information (VMG) and a video title set (VTS) according to the invention;

FIG. 7 is a flowchart to help explain a startup sequence of a player model according to the invention;

FIG. 8 is a table showing the data structure of a DISCID.DAT file in a disc according to the invention;

FIG. 9 is a flowchart to help explain an example of the operation of an apparatus according to the invention;

FIG. 10 is a flowchart to help explain another example of the operation of the apparatus according to the invention;

FIG. 11 is a flowchart to help explain still another example of the operation of the apparatus according to the invention;

FIG. 12 is an exemplary diagram to help explain a pack-mixed state of a primary EVOB-TY2 according to the invention;

FIG. 13 is an exemplary diagram to help explain the concept of recorded information on a disc according to the invention;

FIG. 14 is an exemplary diagram to explain in detail a model of an advanced content player according to the invention;

FIG. 15 is an exemplary diagram to help explain an example of the video mixing model in FIG. 14;

FIG. 16 is an exemplary diagram to help explain an example of a graphic hierarchy in the operation of the apparatus according to the invention;

FIG. 17 is an exemplary diagram to help explain an example of a network and a persistent storage data supply model in the apparatus according to the invention;

FIG. 18 is an exemplary diagram to help explain an example of a data storage model according to the invention;

FIG. 19 is an exemplary diagram to help explain an example of a user input processing model according to the invention;

FIGS. 20A and 20B are exemplary diagrams to help explain a configuration of advanced contents;

FIG. 21 is an exemplary diagram to help explain an example of the configuration of a playlist;

FIG. 22 is an exemplary diagram to help explain an allocation of a presentation object on a timeline;

FIG. 23 is an exemplary diagram to help explain a case where a trick play (e.g., a chapter jump) of a presentation object is made on the timeline;

FIG. 24 is an exemplary diagram to help explain an example of the configuration of a playlist when an object includes angle information;

FIG. 25 is an exemplary diagram to help explain an example of the configuration of a playlist when an object includes a multistory;

FIG. 26 is an exemplary diagram to help explain a descriptive example of object mapping information in the playlist and its playback time;

FIG. 27 is a flowchart to help explain the way the data cache is controlled in the operation of the apparatus according to the playlist;

FIG. 28 is an exemplary diagram showing an example of comments displayed according to the operation of the user interface manager; and

FIG. 29 is an exemplary block diagram showing an overall block configuration of a player according to the invention;

### DETAILED DESCRIPTION

Various embodiments according to the invention will be described hereinafter with reference to the accompanying drawings.

An object of the embodiment is to provide an information reproducing apparatus and an information reproducing method which are capable of adopting system parameters properly according to the type of disc.

According to an aspect of the embodiment, there is provided an information reproducing apparatus comprising: a reproducing section which reproduces contents on the basis of playback management information in order to reproduce the contents of a disc; a continuation control section which changes the setting of the reproducing section according to output setting information and causes the reproducing section to continue the reproduction, when any one of aspect, resolution, and audio used as the output setting information has been changed in the middle of reproducing a first content of the disc; and a graphic user interface control section which outputs a comment to the effect that a replay state starts at an object starting position, when the change of any one of aspect, resolution, and audio used as the output setting information is input a specific time after the start of the reproduction of a second content of the disc.

With the above configuration, the user can check the comment and accept the replay state without a feeling of strangeness.

<Introduction>

The types of contents will be explained.

In the explanation below, two types of contents are determined: one is standard content and the other is advanced content. Standard content which is composed of navigation data and video objects on the disc is an extended DVD-video standard version 1.1.

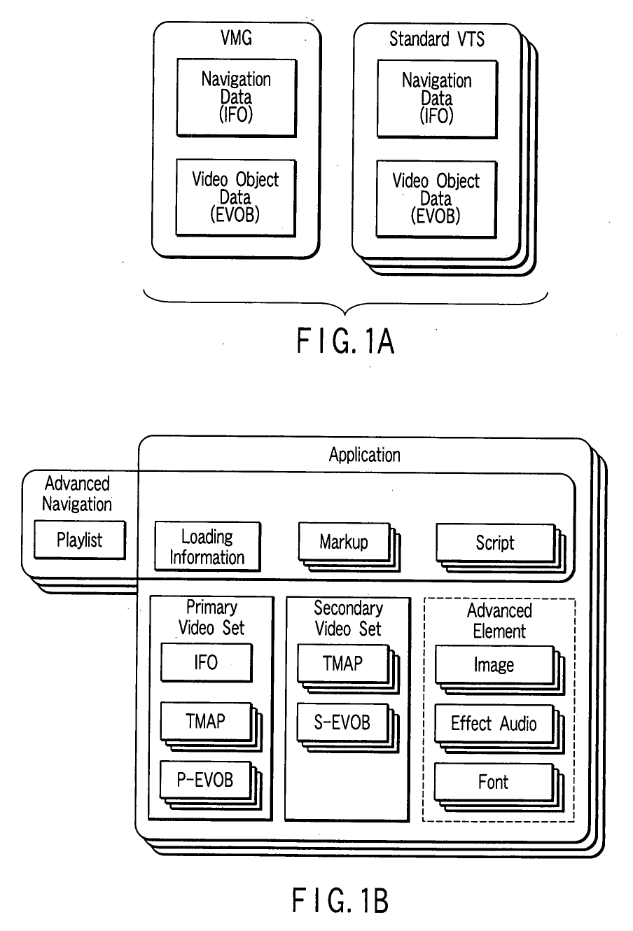

Advanced content is composed of advanced navigation data, such as a playlist, loading information, markup, or script files, and advanced data, such as primary/secondary video sets, and advanced elements (such as, images, audio, or text). In the advanced content, at least one playlist file and one primary video set have to be positioned on the disc and the other data may be placed on the disc or taken in from a server.

<Standard Content (see FIG. 1(A))>

Standard content is an extension of the content determined in the DVD-video standard version 1.1 in terms of high-resolution video, high-quality audio, and several new functions. Standard content is basically composed of one VMG space and one or more VTS spaces (referred to as standard VTS or just VTS).

<Advanced Content (see FIG. 1(B)>

Advanced content realizes not only the extension of audio and video realized in standard content but also higher interactivity. Advanced content is composed of advanced navigation data, such as a playlist, loading information, markup, or script files, and advanced data, such as primary/secondary video sets, and advanced elements (such as, images, audio, or text). Advanced navigation data manages the reproduction of advanced data.

The playlist written in XML is on the disc. When advanced content is on the disc, the player first executes this file. The file offers the following pieces of information:
Object Mapping Information: Information in a title for a presentation object mapped on the title timeline.
Playback Sequence: Playback information for each title written using the title timeline.
Configuration information: System configuration information including data buffer alignment.

When the first application has the primary/secondary video sets in the description of the playlist, the application is executed with reference to these sets. One application is composed of loading information, a markup (including content/styling/timing information), a script, and advanced data. The first markup file, script file, and other resources constituting the application are referred to in one loading information file. According the markup, the reproduction of the advanced data, including the primary/secondary video sets, and the advanced elements is started.

The primary video set is composed of a VTS space for the content only. That is, the VTS has no navigation command and therefore no multilayer structure, but has TMAP information. The VTS can hold one main video stream, one sub-video stream, eight main audio streams, and eight sub-audio streams. The VTS is referred to as “advanced VTS”.

The secondary video set is used not only when video/audio data is added to the primary video set but also when only audio data is added. The data can be reproduced only when the video/audio stream in the primary video set has not been reproduced and vice versa.

The secondary video set is recorded onto a disc or is taken in from a server in the form of one or more files. The data in the file has been recorded on the disc. When the data, together with the primary video set, has to be reproduced simultaneously, it is stored in a file cache temporarily. When the secondary video set is on a website, all the data has to be stored in a file cache temporarily (downloading). Alternatively, part of the data has to be stored continuously in a streaming buffer. The stored data is reproduced simultaneously without causing buffer overflow, while the data is downloaded from the server (streaming).

Description of Advanced Video Title Set (Advanced VTS)

An advanced VTS (also called a primary video set) is used in a video title set for advanced navigation. The following have been determined to correspond to the standard VTS:

1) Further enhancement of EVOB
One main video stream, one sub-video stream
Eight main audio streams, eight sub-audio streams
32 sub-picture streams
One advanced stream

2) Integration Of Enhanced EVOB Sets (EVOBS)
Integration of menu EVOBS and title EVOBS

3) Dissolution of multilayer structure
No title, no PGC (program chain), no PTT (part of title), no cell
Cancellation of navigation commands and UOP (user operation) control

4) Introduction of new time map information (TMAPI)
One TMAPI corresponds to one EVOB and is used as a file.
Part of the information in NV_PCK is simplified.

Description of Interoperable VTS

Interoperable VTS is a video title set supported in the HD DVD-VR standard. In this standard, or the HD DVD-video standard, the interoperable VTS is not supported. That is, a content writer cannot produce a disc including an interoperable VTS. However, HD DVD-video payers support the reproduction of interoperable VTS.

<Disc Type>

In the standard, the following three types of discs (category-1 disc/category-2 disc/category-3 disc) are permitted.

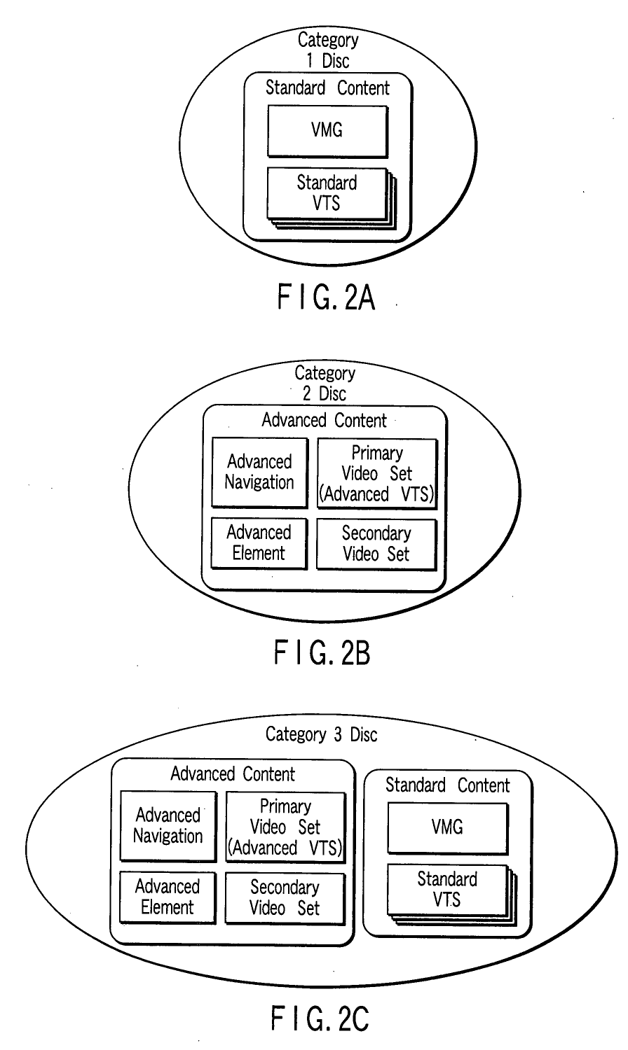

Description of Category-1 Disc (See FIG. 2(A) for an Example of Configuration)

This disc includes only one VMG and standard content composed of one or more standard VTS. That is, the disc includes neither advanced VTS nor advanced content.

Description of Category-2 Disc (See FIG. 2(b) for an Example of Configuration)

This disc includes only advanced content composed of advanced navigation data, a primary video set (advanced VTS), a secondary video set, and advanced elements. That is, the disc includes no standard content (such as VMG or standard VTS).

Description of Category-3 Disc (See FIG. 2(C) for an Example of Configuration)

This disc includes only advanced content composed of advanced navigation data, a primary video set (advanced VTS), a secondary video set, and advanced elements, and standard content composed of VMG (video manager) and one or more standard VTS. The VMG includes neither FP_DOM nor VMGM_DOM.

The disc includes standard contents. According to the category-2 disk rule, the disc basically further includes the transition from the advanced content playback state to the standard content playback state and the transition from the standard HD DVD-video.

<Rules for Directories and Files (FIG. 5)>

The requirements for files and directories related to HD DVD-video discs will be described. In the directories of FIG. 5, the descriptions enclosed by rectangular boxes represent individual file names.

HVDVD_TS Directory

An HVDVD_TS directory is just under the root directory. All the files related to one VMG, one or more standard video sets, and one advanced VTS (primary video set) are under the HVDVD_TS directory.

Video Manager (VMG)

One piece of video manager information (VMGI) “HV00010.IFO”, a first play program chain menu enhanced video object (PF_PGCM_EVOB) “HV000M01.EV0”, backup video manager information (VMGI_BUP) “HV000101.BUP”, and a video manager menu enhanced video object set (VMGM_EVOBS) “HV000M02.EV0” are recorded under the HVDVD_TS directory in the form of configuration files.

Standard Video Title Set (Standard VTS)

Video title set information (VTSI) “HV001101.IFO” and backup video title set information (VTSI_BUP) “HV001101.BUP” are recorded under the HVDVD_TS directory in the form of configuration files. Moreover, a video title set menu enhanced video object set (VTSM_EVOBS) “HV001M01.EV0” and a title enhanced video object set (VTSTT_VOBS) “HV001T01.EV0” are also content playback state to the advanced content playback state.

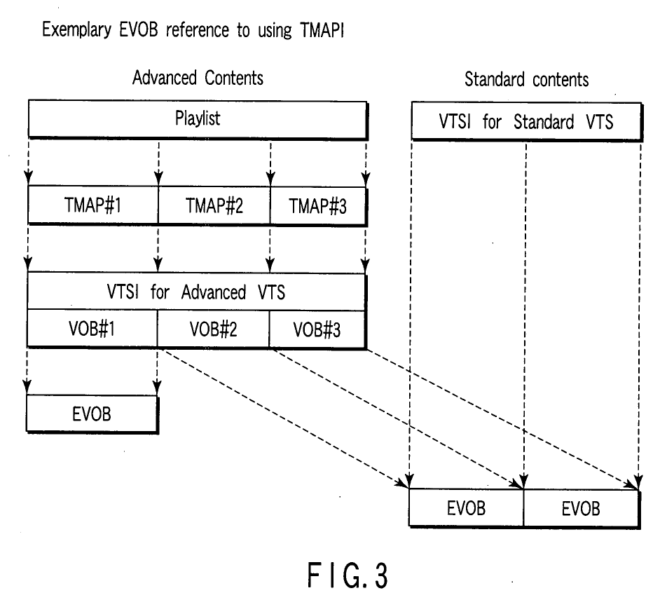

Description of Use of Standard Content by Advanced Content (FIG. 3 Shows the Way Standard Content is Used as Described Above)

Standard content can be used by advanced content. VTSI (video title set information) in the advanced VTS can refer to EVOB. The latter can also be referred to by VTSI in the standard VTS using TMAP. EVOB can include HLI (highlight information), PCI (program control information), and the like. This is not supported by the advance content. In reproducing such EVOB, for example, HLI or PCI is ignored in the advanced content.

<Structure of Volume Space>

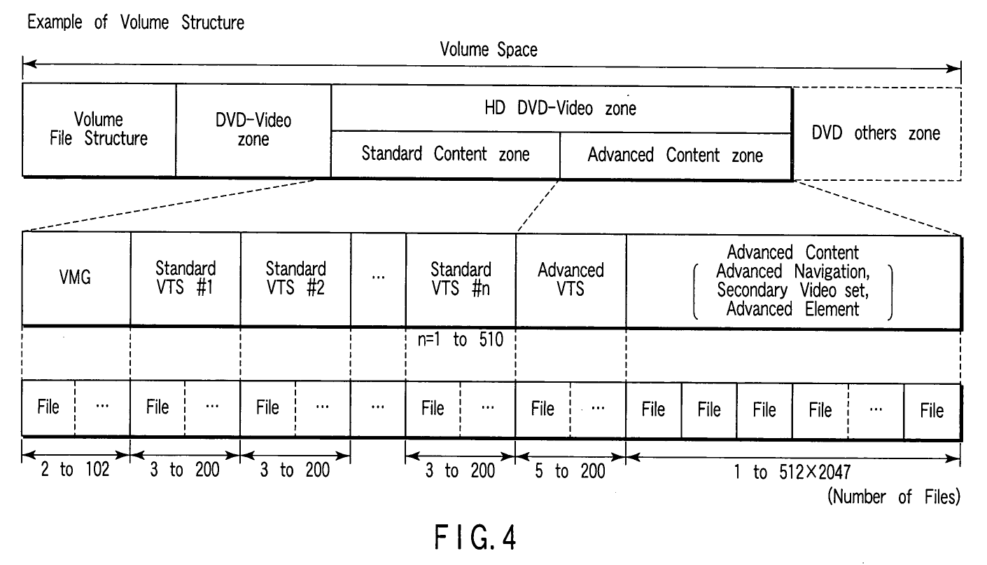

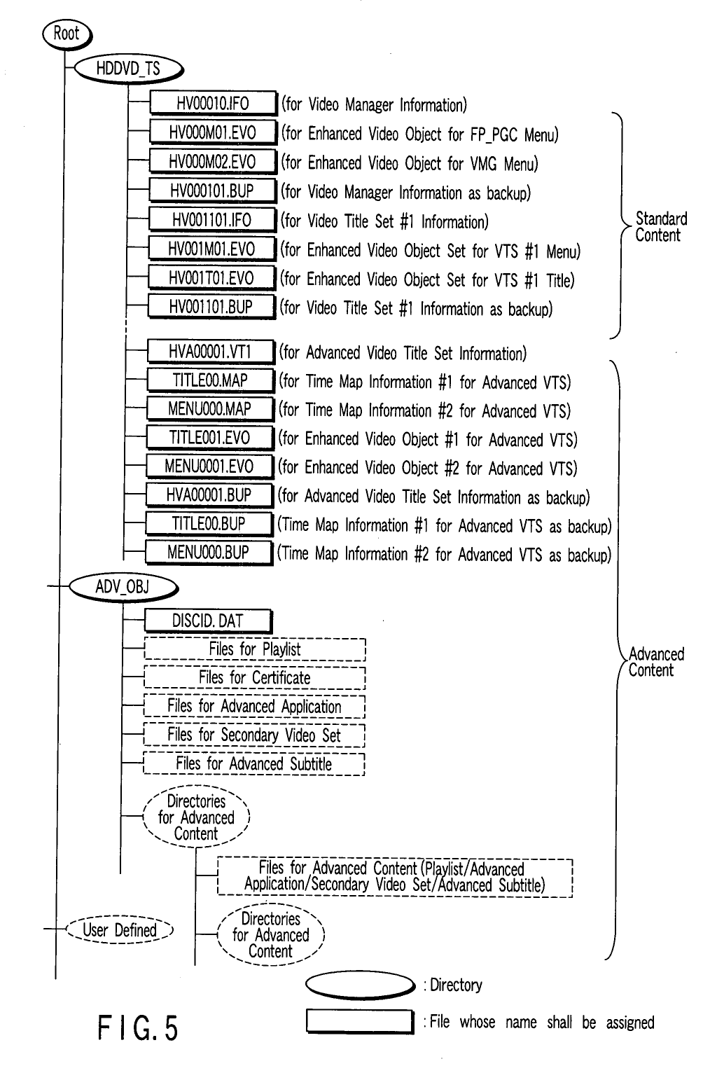

As shown in FIG. 4, a volume space in an HD DVD-video disc is composed of the following elements:

1) Volume and File structure. This is allocated to the UDF structure.

2) A single DVD-video zone. This may be allocated to the data structure of a DVD-video format.

3) A single HD DVD-video zone. This may be allocated to the data structure of a DVD-video format. This zone is composed of a standard content zone and an advanced content zone.

4) A zone for DVD and others. This may be used for an application which is neither DVD-video nor configuration files under the HVDVD_TS directory.

Advanced Video Title Set (Advanced VTS)

One piece of video title set information (VTSI) “HVA00001.VT1” and one piece of backup video title set information (VTSI_BUP) “HVA00001.BUP” can be recorded under the HVDVD_TS directory in the form of configuration files.

Each of video title set time map information (VTS_TMAP) #1 (for titles), #2 (for menus) “TITLE00.MAP”, “MENU000.MAP” and backup video title set time map information (VTS_TMAP_BUP) #1, #2 “TITLE00.BUP”, “MENU000.BUP” is composed of files under the HVDVD_TS directory.

Enhanced video object #1, #2 files “TITLE00.EV0”, “MENU000.EV0” for enhanced video title sets are also configuration files under the HVDVD_TS directory.

The following rules are applied to file names and directory names under the HVDVD_TS directory:

ADV_OBJ Directory

An ADV_OBJ directory is just under the root directory. All the boot files belonging to the advance navigation are under this directory. All the files in the advance navigation, advanced elements, and secondary video set are under this directory.

In addition, just under this directory, a file “DISCID.DAT” unique to the advanced system is provided. This file is a disc identification data file, which will be described in detail later.

All the playlist files are just under this directory. Any one of the advanced navigation, advanced element, and secondary video set files can be placed under this directory.

Playlist

Each playlist file can be placed in the name of, for example, PLALIST%%.XML just under the ADV_OBJ directory. “%%” is allocated consecutively in ascending order from 00 to 99. The playlist file having the largest number (when the disc is loaded) is processed first.

Advance Content Directory

Other directories for advanced contents can be placed only under the ADV_OBJ directory. Any one of the advanced navigation, advanced element, and secondary video set files can be placed under this directory.

Advanced Content File

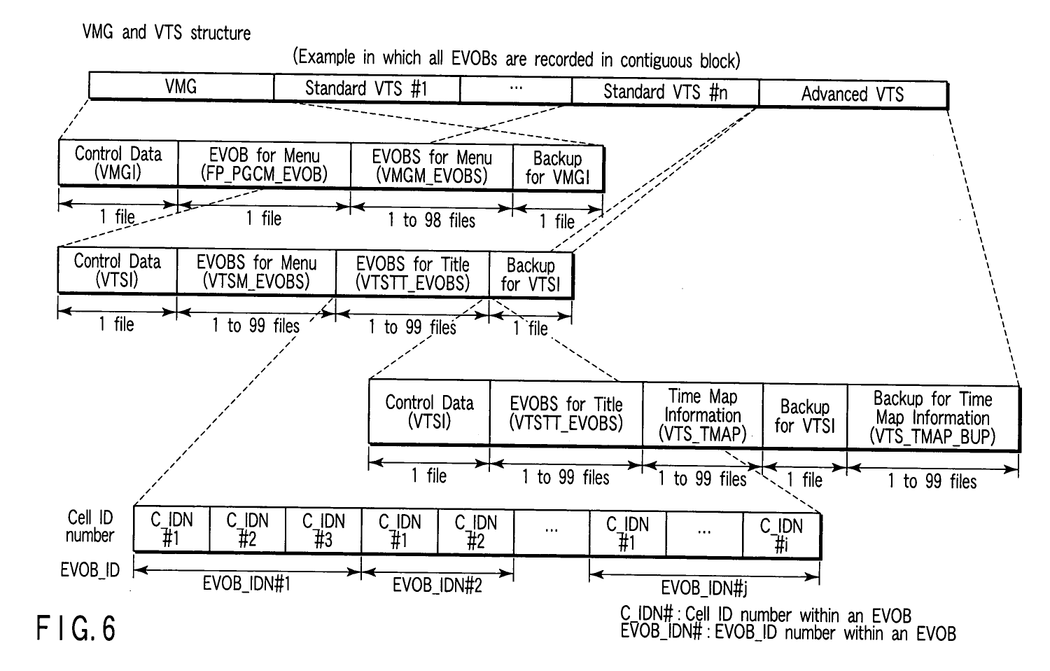

The total number of files under the ADV_OBJ is limited to 512×2047. Let the total number of files in each directory be less than 2048. The file name is composed of d characters or d1 characters. The file name is made up of the body, “.” (period), and an extension. FIG. 6 shows an example of the above-described directory/file structure.

<Structure of Video Manager (VMG) (FIG. 6)>

VMG is a table of contents of all the video title sets in the HD DVD-video zone. As shown in FIG. 6, VMG is composed of control data called VMGI (video manager information), a first play PGC menu enhanced video object (FP_PGCM_EVOB), a BMG menu enhanced video object set (VMGM_EVOBS), and control data backup (VMGI_BUP). The control data is static information necessary to reproduce titles and provides information to support user operations. FP_PGCM_EVOB is an enhanced video object (EVOB) used to select a menu language. VMGM_EVOB is a set of enhanced video objects (EVOB) used in a menu to support volume access.

<Structure of Standard Video Title Set (Standard VTS)>

VTS is a set of titles. As shown in FIG. 6, each VTS is composed of control data called VTSI (video title set information), a VTS menu enhanced video object set (VTSM_EVOBS), a title enhanced video object set (VTSTT_EVOBS), and backup control data (VTSI_BUP).

<Structure of Advanced Video Title Set (Advanced VTS)>

This VTS is composed of only one title. As shown in FIG. 6, the VTS is basically composed of control data called VTSI, a title enhanced video object set in a VTS (VTSTT_EVOBS), video title set time map information (VTS_TMAP), backup control data (VTSI_BUP), and backup of video title set time map information (VTS_TMAP_BUP).

<Structure of Enhanced Video Object Set (EVOBS)>

EVOBS is a set of enhanced video objects composed of video, audio, sub-pictures, and the like (FIG. 6).

The following rules are applied to EVOBS:

1) In an EVOBS, EVOB is recorded in consecutive blocks and interleaved blocks.

2) An EVOBS is composed of one or more EVOBs. EVOB_ID numbers are allocated in ascending order, beginning with EVOB having the smallest LSN (logical sector number) in the EVOBS.

3) An EVOB is composed of one or more cells. C_ID numbers are allocated in ascending order, beginning with a cell having the smallest LSN in the EVOB.

4) A cell in the EVOBS can be identified by EVOB_ID number and C_ID number.

System Model

<Overall Startup Sequence>

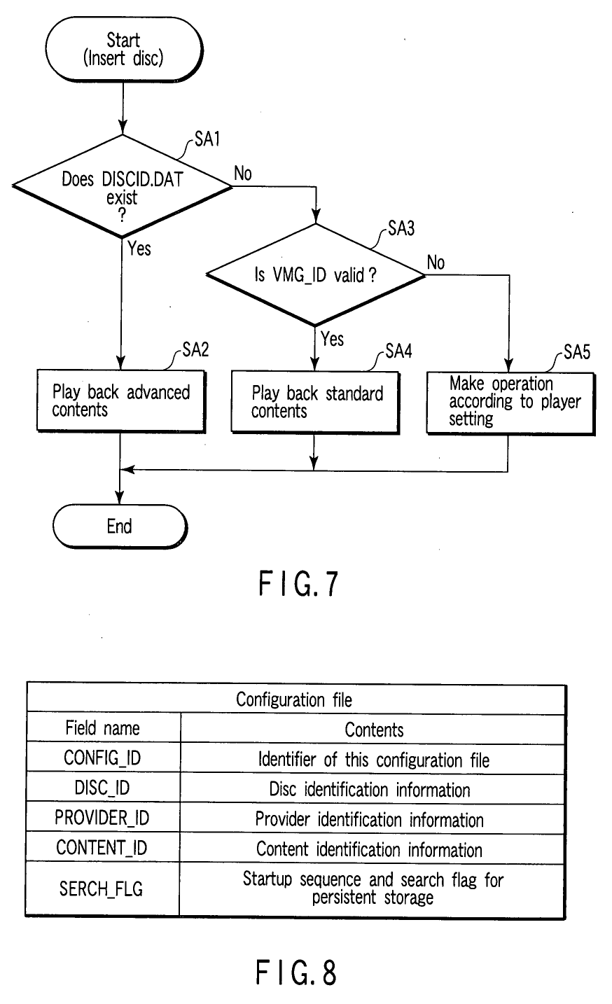

FIG. 7 is a flowchart for a startup sequence of an HD DVD player. After a disc is inserted, the player determines whether file “DISC.DAT” is under the “ADV_OBJ” directory in the management information area (step SA1). “DISC.DAT” is a file unique to a recording medium capable of handling advanced contents. If “DISC.DAT” has been confirmed, control proceeds to the playback mode of advanced contents (step SA2). At this time, the disc is either a category-2 disc or a category-3 disk. If “DISC.DAT” has not been confirmed in step SA1, whether “VMG_ID” is valid is confirmed (step SA3). Whether “VMG_ID” is valid is confirmed as follows. If the disc is under category 1, “WMG_ID” is “HVDVD-VMG100”. In addition, bit 0 to bit 3 in VMG_CAT which is a category description area, represent “No Advanced VTS exists”. In this case, the player goes to the standard content playback mode (step SA4). Moreover, if it has been found that the disc does not belong to any HD_DVD type, the operation follows the setting of the player (step SA5).

When having moved to the playback of advanced contents, the player goes to the operation of reading and reproducing “playlist.xml (Tentative)” in “ADV_OBJ” directory under the root directory. The startup sequence and memory for the sequence may be provided in the data access manager or navigation manager.

FIG. 8 is a table showing the data structure of “DISCID.DAT”. “DISCID.DAT” is a file name, also referred to as a configuration file. In the file, a plurality of fields are secured. The fields include “CONFIG_ID”, “DISC_ID”, “PROVIDER_ID”, “CONTENT_ID”, and “SERCH_FLG”.

In the field of “CONFIG_ID”, “HDDVD-V_CONFG” for identifying this file is written using a code complying with ISO 8859-1.

In the field of “DISC_ID”, a disk ID is written.

In the field of “PROVIDER_ID”, studio ID is written. From this information, the content provider can be identified. A persistent storage has an independent area for storing data for each provider on the basis of provider ID. In the field of “CONTENT_ID”, identification data on the advanced content is written. This content ID can also be used to search for the playlist file in the persistent storage.

In the field of “SERCH_FLAG”, a search flag for searching the persistent storage for a file at the time of the start sequence is written. When the flag is 1, this means that the persistent storage is not used. When the flag is 0, this means that the persistent storage is used. Therefore, when the flag is 0, the player searches both of the disc and the persistent storage for the playlist file. When the flag is 1, the player searches only the disc for the playlist at the time of the start-up.

Accordingly, the data in the configuration file is used to identify the area allocated to the disc in the persistent storage. Moreover, the data is also used to authenticate the disc through the network. For example, using information on the provider, it is possible to search for the server that has information on the disc.

When the resume function operates, the player according to the invention carries out the process related to the data structure of “DISCID.DAT”.

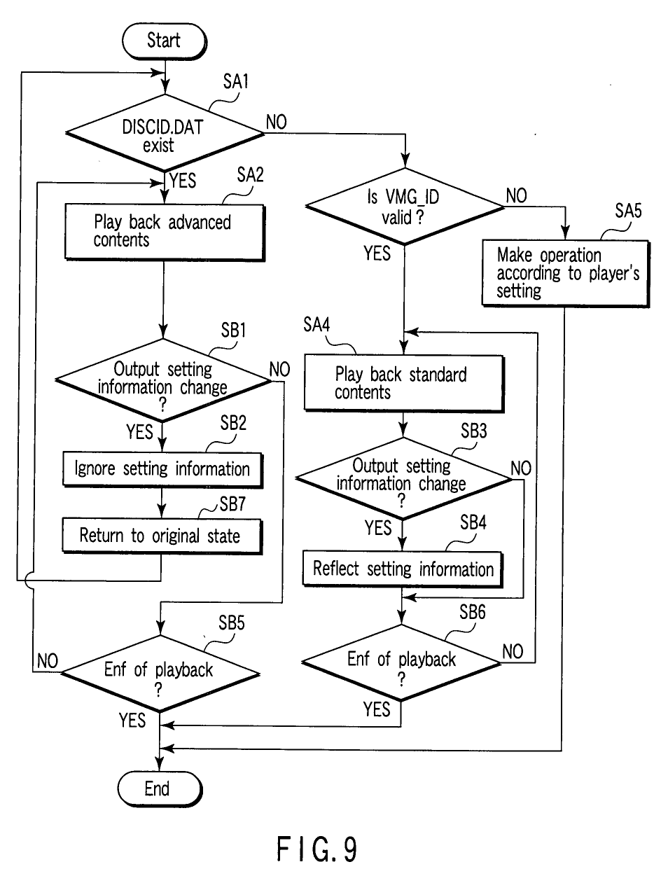

FIG. 9 is a flowchart to help explain an example of the operation when output setting information (system parameters) has been changed. When the advanced content is in the playback state (step SA2), if the output setting information has been changed, the setting information is ignored (step SB2). Then, in this case, for example, control returns to the original state (step SA1). Then, setting information is set again in the reproducing section and playback is started. When the playback is completed (step SB5), the operation of the player ends.

In contrast, when the standard content is in the playback state (step SA4), if the output setting information has been changed, the setting information is reflected on the player (step SB4). When the playback is completed (step SB6), the operation of the player ends.

The output setting information includes setting information on aspect, setting information on resolution, setting information on audio output, and setting information on HDMI (high-definition multimedia interface). Aspect setting information includes 4:3 and 16:9. Resolution setting information includes 480 pixels per line, 720 pixels per line, and 1080 pixels per line.

Audio output setting information includes the number of output channels and the parameters for the audio system (PCM, Dolby, or MPEG system) which supports the main audio and sub-audio. HDMI setting information includes the up-conversion and down-conversion of image data.

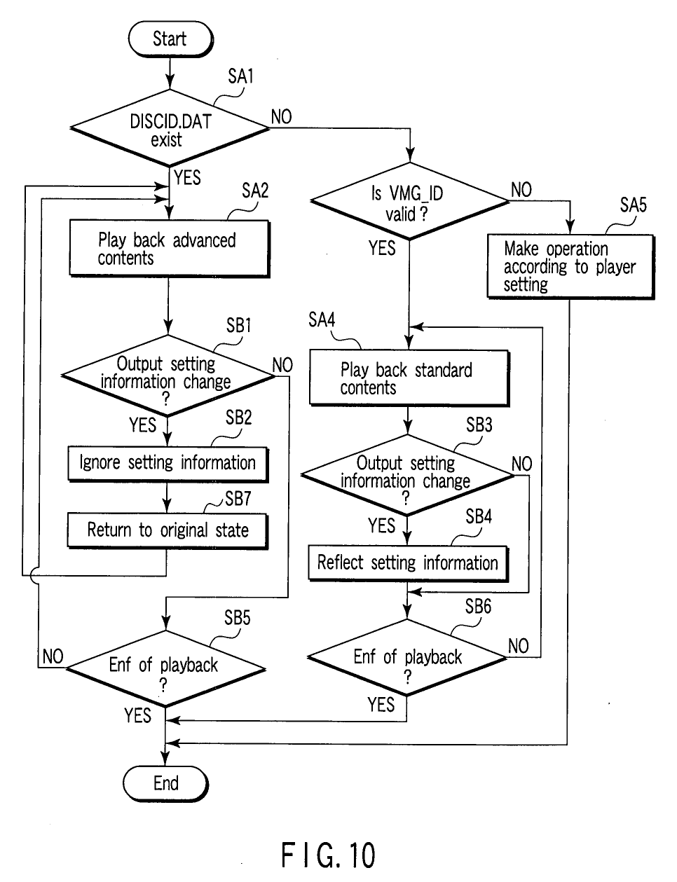

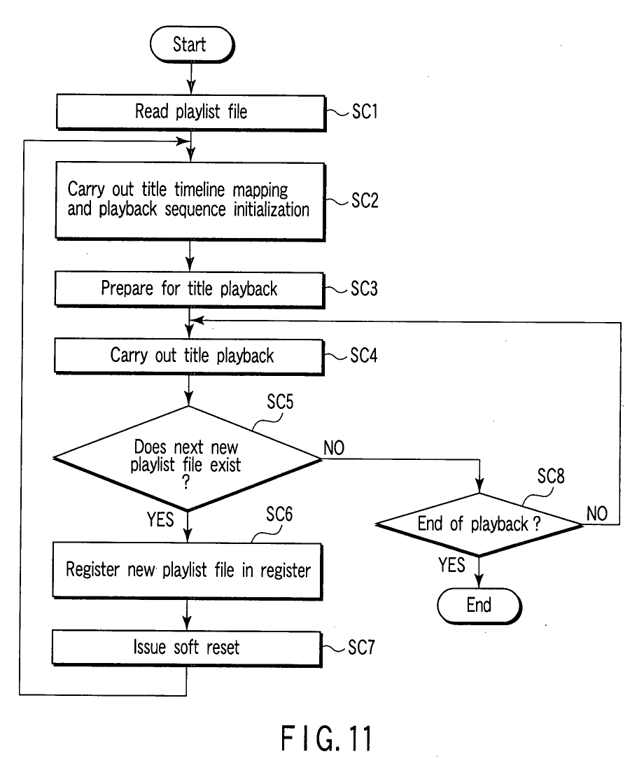

FIG. 10 is a flowchart to help explain another example of the sequence shown in FIG. 9. In FIG. 9, when the output setting information has been changed, if the advanced content is to be reproduced, control is returned to step SA1. However, in the case of the advanced content, DISCID.DAT may be left in the memory return control to step SA2 (step SB7).

In this case, control proceeds to the playback of the advanced content as shown in FIG. 11.

The reading of the playlist file is done (step SC1). Using the next playlist, the title timeline is mapped and the playback sequence is initialized (step SC2). Then, the playback of the first title is prepared (step SC3) and the playback of the title is started (step SC4). As a result, the advanced content player plays back the title. Next, it is determined whether there is a new playlist file (step SC5). To update the playback of the advanced content, an advanced application to execute the update sequence is required. When the advanced application updates its presentation, the advanced application of the disc has to search for the script sequence beforehand. The programming script searches for a specified data source, normally a network server, regardless of where there is a new available playlist file. When there is a new playlist file, the playlist file is registered (step SC6). When there is a new available playlist file, the script executed by the programming engine downloads the playlist file into a file cache and registers it in the advanced content player. After the new playlist file has been registered, the advanced navigation issues soft reset API (step SC7) and restarts the startup sequence. The soft reset API resets all of the present parameters and the playback configuration and restarts the startup sequence immediately after the reading of the playlist file. The change of the system configuration and the subsequence sequence are carried out on the basis of the newly read playlist file.

The reason for going back to the first playback state of the content as described above is that the following consideration has been made. As for advanced contents, providers are allowed to design as follows: (1) applications and contents may be prepared according to the resolution; (2) applications and contents may be prepared according to the aspect; (3) applications and contents may be prepared according to the audio output environment; and (4) applications and contents may be prepared according to the use of HDMI.

Therefore, if the resolution or the like has been changed in the middle of playback, there is no guarantee that the application compatible with the resolution is enabled properly. To give such a guarantee, this apparatus returns to the first playback state, when the output environment has changed in the middle of playback.

In playing back the advanced content, an interactive operation can be performed according to the user operation. Therefore, according to the user operation, the next playback route or playback position on the content is changed or switched.

Accordingly, when the output setting information has been changed during playback, the operations as shown in FIGS. 9 and 10 are needed.

In FIGS. 9 and 10, a display process explained later may be further carried out in step SB2 where the setting information is ignored. Specifically, when a specific time (e.g., 20 minutes) has passed since the start of the playback of the advanced content, a comment is output to the user. The comment is made to the effect that replaying is to be done. Here, if the user presses the decide button on the remoter controller, replaying is done. However, even when the comment has been displayed, if it is left as it is, the playback is continued in the present environment without replaying.

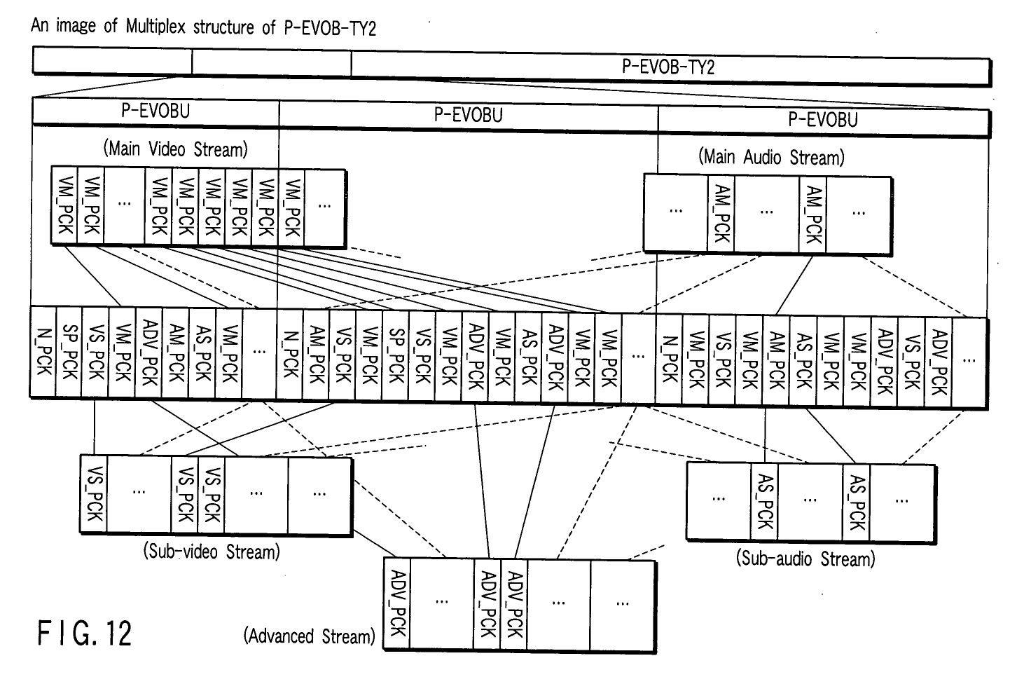

FIG. 12 is a diagram to help explain a multiplexed structure of P-EVOB-TY2 as advanced content. P-EVOB-TY2 includes an enhanced video object unit (P-EVOBU). The PEVOBU includes a main video stream, a main audio stream, a sub-video stream, a sub-audio stream, and an advanced stream.

At the time of playback, a packet multiplexed stream of P-EVOB-TY2 is input to a De-Multiplex via a track buffer. Here, the packets are separated according to their types and supplied to a main video buffer, a sub-video buffer, a sub-picture buffer, a PCI buffer, a main audio buffer, and a sub-audio buffer. The outputs of the respective buffers can be decoded by the corresponding decoders.

<Data Source>

Next, the types of data sources usable in the reproduction of advanced contents will be explained.

<Disc>

A disc 131 is an essential data source for the reproduction of advanced contents. The HD DVD player has to include an HD DVD disc drive. Authoring has to be done in such a manner that advanced contents can be reproduced even if usable data sources are only a disc and an essential persistent storage.

<Network Server>

The network server 132 is an optional data source for the reproduction of advanced contents. The HD DVD player must have the capability to access a network. The network server is usually operated by the content provider of the present disc. The network server is generally placed on the Internet.

<Persistent Storage>

The persistent storage 133 is divided into two categories.

One is called Fixed Persistent Storage. This is an essential persistent storage attached to the HD DVD player. A typical one of this type of storage is a flash memory. The minimum capacity of the fixed persistent storage is 64 MB.

Others, which are optional, are called auxiliary persistent storages. These may be detachable storage units, such as USB memory/HDD or memory cards. One of conceivable auxiliary storage units is NAS. In this standard, the implementation of the unit has not been determined. They must follow the API model for persistent storages.

<About Disc Data Structure>

<Types of Data on Disc>

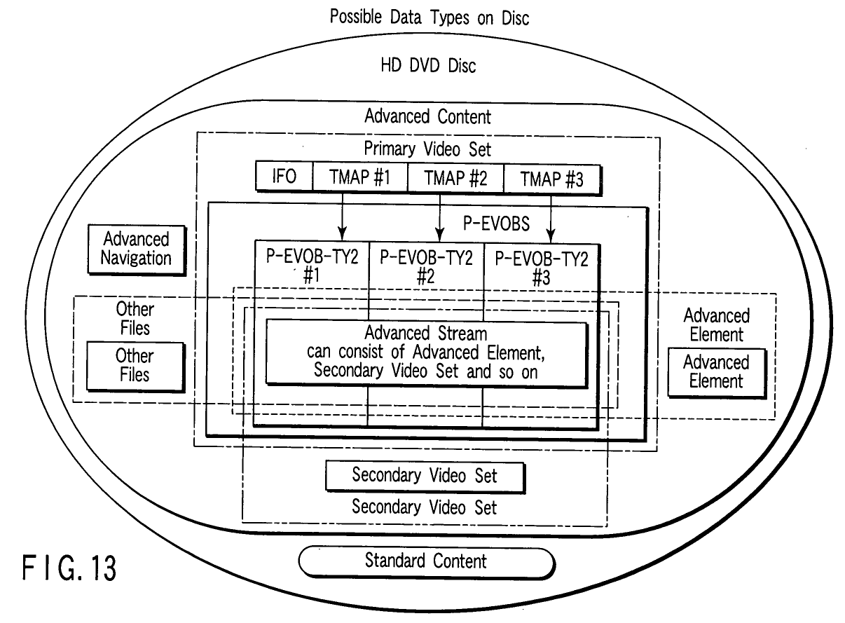

FIG. 13 shows the types of data storable on the HD DVD disc. The disc can store advanced contents and standard contents. The data types of advanced contents include advanced navigation, advanced elements, primary video sets, and secondary video sets.

FIG. 13 shows an example of the types of data on the disc. An advanced stream has a data format used to archive advanced content files of any type excluding primary video sets. The advanced stream is multiplexed with the primary enhanced video object type 2 (P-EVOBS-TY2) and then is taken out together with P-EVOBS-TY2 data supplied to the primary video player.

The same file archived in the advanced stream and indispensable for reproducing advanced contents has to be stored as a file. These reproduced copies guarantee the reproduction of advanced contents. The reason is that, when the reproduction of the primary video set is jumped, the supply of the advanced stream may not have been completed. In this case, before the reproduction is resumed at the specified jump position, the necessary file is read directly from the disc into the data cache.

Advanced Navigation: An advanced navigation file is ranked as a file. The advanced navigation file is read during the startup sequence and is interpreted for the reproduction of advanced contents.

Advanced Element: An advanced element can be ranked as a file and further can be archived in an advanced stream multiplexed with P-EVOB-TY2.

Primary Video Set: Only one primary video set exists on the disc.

Secondary Video Set: A secondary video set can be ranked as a file and further can be archived in an advanced stream multiplexed with P-EVOB-TY2.

Other Files: Other files may exist, depending on the advanced content.

<Type of Data on Network Server and Persistent Storage>

All of the advanced content files excluding primary video sets can be placed on the network server and persistent storage. Using proper API, advanced navigation can copy a file on the network server or persistent storage into the file cache. The secondary video player can read a secondary video set from the disc, network server, or persistent storage into the streaming buffer. Advanced content files excluding primary video sets can be stored into the persistent storage.

<Model of Advanced Content Player>

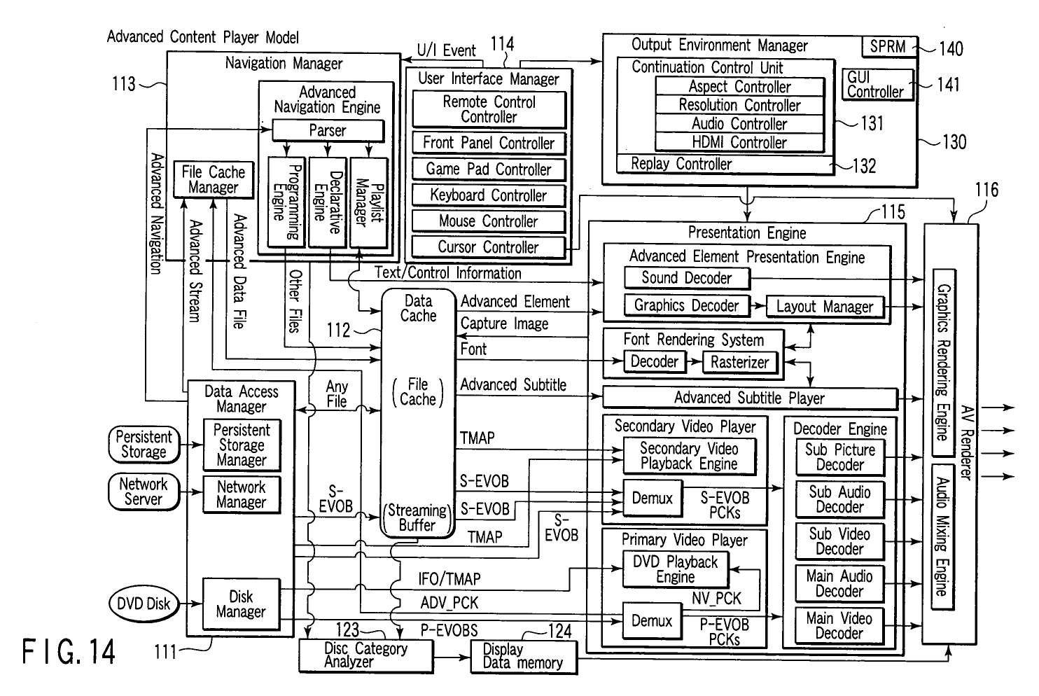

FIG. 14 shows a detailed model of the advanced content player.

The advanced content player is a logical player for advanced contents. The data sources of advanced contents include the disc 131, network server 132, and persistent storage 133. The advanced content player can deal with the data sources.

Any data type of advanced contents can be stored on the disc. Advanced contents for the persistent storage and network server can hold any data type excluding primary video sets.

A user event input is created by a user input unit, such as the remote controller or front panel of the HD DVD player. The advanced content player does the job of inputting a user event to the advanced content and creating a proper response. The audio and video outputs are sent to a speaker and a display unit, respectively.

The advanced content player is a logical player for advanced contents. The player basically comprises the following six logical function modules: a data access manager 111, a data cache 112, a navigation manager 113, a user interface manager 114, a presentation engine 115, and an AV renderer 116. These constitute a reproducing section.

The player further comprises a disc category analyzer 123 and a display data memory 124. On the basis of the information and instruction taken in by the data cache 112 and the navigation manager 113, the disc category analyzer 123 determines the category of the currently installed disc. With a category-3 disc being installed, when the playback state of advanced contents transits to the playback state of standard contents, or vice versa, the state can be detected.

Furthermore, an output environment manager 130 is provided. The output environment manager 130 responds mostly to the user operation and changes the output setting information (or system parameters), thereby setting the output configuration. For example, the output environment manager 130 sets an aspect, a resolution, an audio output channel, and the like. The position in which the output environment manager 130 is provided is not limited to the position shown in the figure. For instance, the output environment manager 130 may be incorporated into another block.

To play back the disc, the reproducing section which plays back the disc on the basis of the playback management information is basically composed of the disc access manager 111, data cache 112, navigation manager 113, user interface manager (or graphic user interface control section) 114, and presentation engine 115. The output setting information is supplied to the block of the decoder engine in the presentation engine 115.

The output environment manager 130 includes a continuation controller 131 and a replay controller (or replay control section) 132.

When any one of the aspect, resolution, and audio in the output setting information has been changed in the middle of reproducing the standard contents, the continuation controller 131 changes the setting of the reproducing section according to the output setting information and continues the reproduction. The continuation controller 131 includes an aspect controller, a resolution controller, an audio controller, and an HDMI controller. Each of the controllers operates according to the command input via the user interface manger 114 by the user operation. Alternatively, each controller operates when the power supply of the apparatus is turned on. When the power supply has been turned on, the output setting state when the power supply was turned off last time is set in the player.

The aspect controller can set an aspect of 4:3, 16:9, or the like by controlling the presentation engine. The resolution controller can set 480 pixels per line, 720 pixels per line, and 1080 pixels per line by controlling the presentation engine. The audio controller can set the number of output channels and the audio system (PCM, Dolby, or MPEG system) which supports the main audio and sub-audio. The HDMI controller can set the up-conversion and down-conversion of image data.

In contrast, when any one of the aspect, resolution, and audio in the output setting information has been changed in the middle of reproducing the standard contents, the replay controller 132 causes the reproducing section to reproduce the object from the object starting position. The operation at this time is as explained in FIGS. 9, 10, and 11.

In the embodiment of FIG. 9, when setting the playback state beginning from the object starting position, the replay controller 132 starts to read the disk identification data file (DISCID.DAT) under a directory of the disc. In the embodiment of FIG. 10, when setting the playback state beginning from the object starting position, the replay controller 132 sets the playlist in a read playback state.

A configuration for setting an output environment is provided using, for example, the system parameters in a system parameter memory (nonvolatile memory) 140. Information on the system parameters and others will be explained later.

In the system, a graphic interface controller (GUI controller) 141 may be provided.

When the user has carried out the operation of changing the output environment, the GUI controller 141 can display a comment to the user via the display. This will be explained later.

As for advanced contents, providers are allowed to design as follows: (1) applications and contents may be prepared according to the resolution;

(2) applications and contents are prepared according to the aspect; (3) applications and contents are prepared according to the audio output environment; and (4) applications and contents are prepared according to the use of HDMI. Therefore, if the resolution or the like has been changed in the middle of playback, there is no guarantee that the application compatible with the resolution is enabled properly. To give such a guarantee, this apparatus perform replay control, when the output environment has changed in the middle of playback.

<Hereinafter, the Advanced Content Player Will be Explained>

<Data Access Manager>

The data access manager is composed of a disc manager, a network manager, and a persistent storage manager. The data access manager 111 manages the exchange of various types of data between the data sources and the advanced content player.

The data cache 112 is a temporary data storage for playback advanced contents.

Persistent Storage Manager: Persistent storage manager controls the exchange of data between a persistent storage unit and the internal modules of the advanced content player. The persistent storage manager has the function of providing a file access API set to the persistent storage unit. The persistent storage unit can support the file reading/writing function.

Network Manager: the network manager controls the exchange of data between a network server and the internal modules of the advanced content player. The network manager has the function of providing a file access API set to the network server. The network server usually supports the download of files. Some network servers can also support the upload of files. Navigation manager can execute the download/upload of files between the network server and the file cache according to the advanced navigation. In addition to this, the network manager can provide an access function at a protocol level to the presentation engine. The secondary video player in the presentation engine can use these API sets for streaming from the network server.

<Data Cache>

Data caches are available in two types of temporary storage. One is a file cache acting as a file data temporary buffer. The other is a streaming buffer acting as a streaming data temporary buffer. The allocation of streaming data in the data cache is described in “playlist00.xml. The data is divided in the startup sequence of the reproduction of advanced contents. The size of the data cache is 64 MB minimum. The maximum is undecided.

Initialization of data cache: The configuration of the data cache is changed in the startup sequence of the reproduction of advanced contents. In “playlist00.xml”, the size of the streaming buffer can be written. If there is no description of the streaming buffer size, this means that the size of the streaming buffer is zero. The number of bytes in the streaming buffer size is calculated as follows:

$$< streamingBuf size = “ 1024 ” / > \\ Streaming buffer size = 1024 \times 2 ( KB ) = 2048 ( KB )$$

The minimum size of the streaming buffer is zero byte and the maximum size is undecided.

File Cache: A file cache is used as a temporary file cache between a data source, a navigation engine, and a presentation engine. Advanced content files of graphics images, effect sound, text, fonts, and others have to be stored in the file cache before they are accessed by the navigation manager or advanced presentation engine.

Streaming Buffer: A streaming buffer is used as a temporary data buffer for secondary video sets by the secondary video presentation engine of the secondary video player.

The secondary video player requests the network manager to load a part of the secondary video set S-EVOB into the streaming buffer. The secondary video player reads SEVOB data from the streaming buffer and provides the data to the demultiplexer module (Demux) of the secondary video player.

<Navigation Manager>

The navigation manager 113 has the function of controlling any functional module in the advanced content player according to the description of the advanced navigation.

The navigation manager 113 is mainly composed of two types of functional modules. They are an advanced navigation engine and a file cache manager.

Advanced Navigation Engine: The advanced navigation engine controls all of the operation of reproducing advanced contents and further controls the advanced presentation engine according to the advanced navigation. The advanced navigation engine includes a parser, a declarative engine, and a programming engine.

Parser: The parser reads in advanced navigation files and analyzes their syntaxes. The result of the analysis is sent to a suitable module, declarative engine, and programming engine.

Declarative Engine: The declarative engine manages and controls the declared operation of advanced contents according to the advanced navigation. In the declarative engine, the following processes are carried out:
The advance presentation engine is controlled. That is,
Layout of graphics objects and advanced text
Style of graphics objects and advanced text
Timing control of a planned graphics plane operation and an effect sound reproduction
The primary video player is controlled. That is,
Configuration of a primary video set including the registration of title playback sequence (title timeline)
Control of a high-level player
The secondary video player is controlled. That is,
Configuration of a secondary video set
Control of a high-level player

Programming Engine: The programming engine manages event-driven behaviors, API (Application Interface) set calls, or all advanced contents. Since the user interface event is usually handled by the programming engine, the operation of the advanced navigation defined in the declarative engine may be changed.

File Cache Manager: The file cache manager carries out the following processes:
Providing the files archived in the advanced stream of P-EVOBS from the demultiplexer module of the primary video player
Providing the files archived in the network server or persistent storage
Managing the life time of files in the file cache
Acquiring a file when a request file from the advanced navigation or presentation engine has not been stored in the file cache

The file cache manager is composed of an ADV_PCK buffer and a file extractor.

ADV_PCK buffer: The file cache manager receives PCK of the advanced stream archived in P-EVOBS-TY2 from the demultiplexer module of the primary video player. The PS header of the advanced stream PCK is eliminated and basic data is stored in the ADV_PCK buffer. Moreover, the file cache manager acquires an advanced stream file in the network server or persistent storage.

File Extractor: The file extractor extracts an archived file from the advanced stream into the ADV_PCK buffer. The extracted file is stored in the file cache.

<Presentation Engine>

The presentation engine 115 has the function of reproducing presentation materials, such as advanced elements, primary video sets, or secondary video sets.

The presentation engine decodes presentation data and outputs an AV renderer according to a navigation command from the navigation engine. The presentation engine includes four types of modules: advanced element presentation engine, secondary video player, primary video player, and decoder engine.

Advanced Element Presentation Engine: The advanced element presentation engine outputs two types of presentation streams to an AV renderer. One is a frame image of a graphics plane and the other is an effect sound stream. The advanced element presentation engine is composed of sound decoder, graphics decoder, text/font rasterizer, or font rendering system, and layout manager.

Sound Decoder: The sound decoder reads a WAV file from the file cache and outputs LPCM data to the AV renderer started up by the navigation engine.

Graphics Decoder: The graphics decoder acquires graphics data, such as PNG images or JPEG images, from the file cache. The graphics decoder decodes these image files and sends the result to the layout manager at the request of the layout manager.

Text/Font Rasterizer: The text/font rasterizer acquires font data from the file cache and creates a text image. The text/font rasterizer receives text data from the navigation manager or file cache. The text/font rasterizer creates a text image and sends it to the layout manager at the request of the layout manager.

Layout Manager: The layout manager creates a frame image of a graphics plane for the AV renderer. When the frame is changed, the navigation manager sends layout information. The layout manager calls the graphics decoder and decodes a specific graphics object to be set on the frame image. Moreover, the layout manager calls the text/font rasterizer and similarly creates a specific text object to be set on the frame image. The layout manager places a graphical image in a suitable place, beginning with the lowest layer. When the object has an alpha channel or a value, the layout manager calculates a pixel value. Finally, the layout manager sends the frame image to the AV renderer.

Advanced Subtitle Player: The advanced subtitle player includes a timing engine and a layout engine.

Font Rendering System: The font rendering system includes a font engine, a scaler, an alphamap Generation, and a font cache.

Secondary Video Player: The secondary video player reproduces auxiliary video contents, auxiliary audio, and auxiliary subtitles. These auxiliary presentation contents are usually stored in a disc, a network, and a persistent storage. When the contents are stored on a disc, it cannot be accessed from the secondary video player unless it has been stored in the file cache. In the case of a network server, the content has to be instantly stored into the streaming buffer before being provided to the demultiplexer/decoder, thereby avoiding data loss due to fluctuations in the bit rate in the network transfer path. The secondary video player is composed of a secondary video playback engine and a demultiplexer secondary video player. The secondary video player is connected to a suitable decoder of the decoder engine according to the stream type of the secondary video set.

Since two audio streams cannot be stored simultaneously into the secondary video set, the number of audio decoders connected to the secondary video player is always one.

Secondary Video Playback Engine: The secondary video playback engine controls all of the functional modules of the secondary video player at the request of the navigation manager. The secondary video playback engine reads and analyzes a TMAP file and finds a suitable reading position of S-EVOB.

Demultiplexer (Dmux): The demultiplexer reads in an S-EVOB stream and sends it to a decoder connected to the secondary video player. Moreover, the demultiplexer outputs a PCK of S-EVOB with SCR timing. When S-EVOB is composed of a stream of video, audio, or advanced subtitle, the demultiplexer provides it to the decoder with suitable SCR timing.

Primary Video Player: The primary video player reproduces a primary video set. The primary video set has to be stored on a disc. The primary video player is composed of a DVD playback engine and a demultiplexer. The primary video player is connected to a suitable decoder of the decoder engine according to the stream type of the primary video set.

DVD Playback Engine: The DVD playback engine controls all of the functional modules of the primary video player at the request of the navigation manager. The DVD playback engine reads and analyzes IFO and TMAP. Then, the DVD playback engine finds a suitable reading position of P-EVOBS-TY2, selects multi-angle or audio/sub-pictures, and controls special reproducing functions, such as sub-video/audio playback.

Demultiplexer (Demux): The demultiplexer reads P-EVOBS-TY2 into the DVD playback engine and sends it to a suitable decoder connected to the primary video set. Moreover, the demultiplexer outputs each PCK of P-EVOB-TY2 to each decoder with SCR timing. In the case of multi-angle streams, suitable interleaved blocks of P-EVOB-TY2 on the disc are read according to TMAP or positional information in the navigation pack (N_PCK). The demultiplexer provides a suitable number of the audio pack (A_PCK) to the main audio decoder or sub-audio decoder and a suitable number of the sub-picture pack (SP_PCK) to the SP decoder.

Decoder Engine: The decoder engine is composed of six types of decoders: a timed text decoder, a sub-picture decoder, a sub-audio decoder, a sub-video decoder, a main audio decoder, and a main video decoder. Each decoder is controlled by the playback engine of the player to which the decoder is connected.

Timed Text Decoder: The timed text decoder can be connected only to the demultiplexer module of the secondary video player. At the request of the DVD playback engine, the timed text decoder decodes an advanced subtitle in the format based on timed text. Between the timed text decoder and the sub-picture decoder, one decoder can be activated simultaneously. An output graphics plane is called a sub-picture plane and is shared by the output of the timed text decoder and that of the sub-picture decoder.

Sub-Picture Decoder: The sub-picture decoder can be connected to the demultiplexer module of the primary video player. The sub-picture decoder decodes sub-picture data at the request of the DVD playback engine. Between the timed text decoder and the sub-picture decoder, one decoder can be activated simultaneously. An output graphics plane is called a sub-picture plane and is shared by the output of the timed text decoder and that of the sub-picture decoder.

Sub-Audio Decoder: The sub-audio decoder can be connected to the demultiplexer module of the primary video player and that of the secondary video player. The sub-audio decoder can support two audio channels at a sampling rate of up to 48 kHz. This is called sub-audio. Sub-audio is supported as a sub-audio stream in the primary video set, an audio-only stream in the secondary video set, and further an audio/video multiplexer stream in the secondary video set. An output audio stream of the sub-audio decoder is called a sub-audio stream.

Sub-Video Decoder: The sub-video decoder can be connected to the demultiplexer module of the primary video player and that of the secondary video player. The sub-video decoder can support an SD resolution video stream called sub-video (the maximum support resolution to be prepared). The sub-video is supported as a video stream in the secondary video set and a sub-video stream in the primary video set. The output video plane of the sub-video decoder is called a sub-video plane.

Main Audio Decoder: The primary audio decoder can be connected to the demultiplexer module of the primary video player and that of the secondary video player. The primary audio decoder can support 7.1 audio multichannel at a sampling rate of up to 96 kHz. This is called main audio. Main audio is supported as a main audio stream in the primary video set and an audio-only stream in the secondary video set. An output audio stream of the main audio decoder is called a main audio stream.

Main Video Decoder: The main video decoder is connected only to the demultiplexer of the primary video player. The main video decoder can support a HD resolution video stream. This is called support main video. The main video is supported only in the primary video set. The output video plane of the main video decoder is called a main video plane.

<AV Renderer>

The AV renderer 116 has the function of mixing the video/audio inputs from other modules and outputting signals to an external unit, such as a speaker or a display.

The AV renderer has two functions. One function of the AV renderer is to acquire graphics planes from the presentation engine, interface manager, and output mixed video signals. The other function is to acquire PCM streams from the presentation engine and output mixed audio signals. The AV renderer is composed of a graphic rendering engine and a sound mixing engine.

Graphic Rendering Engine: The graphic rendering engine acquires four graphics planes from the presentation engine and one graphic frame from the user interface. The graphic rendering engine combines five planes according to control information from the navigation manager and outputs the combined video signal.

Audio Mixing Engine: The audio mixing engine can acquire three LPCM streams from the presentation engine. The sound mixing engine combines three LPCM streams according to mixing level information from the navigation manager and outputs the combined audio signal.

<User Interface Manager>

The user interface manager 114 has the function of controlling a user interface unit, such as the remote controller or front panel of the HD DVD player. The user interface manger 114 informs the navigation manager 113 of the user input event.

As shown in FIG. 14, the user interface manager includes the following user interface device controllers: a front panel controller, a remote control controller, a keyboard controller, a mouse controller, a game pad controller, and a cursor controller. Each controller checks whether the device can be used and monitors user operation events. User input events are notified to the event handler of the navigation manager.

The cursor manager controls the shape and position of the cursor. The cursor manager updates the cursor plane according to the moving event from a related device, such as the mouse or game panel.

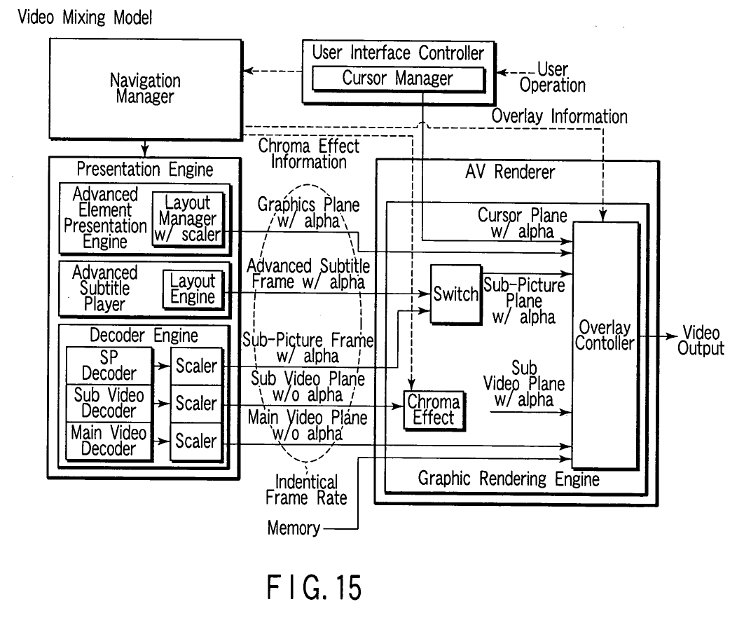

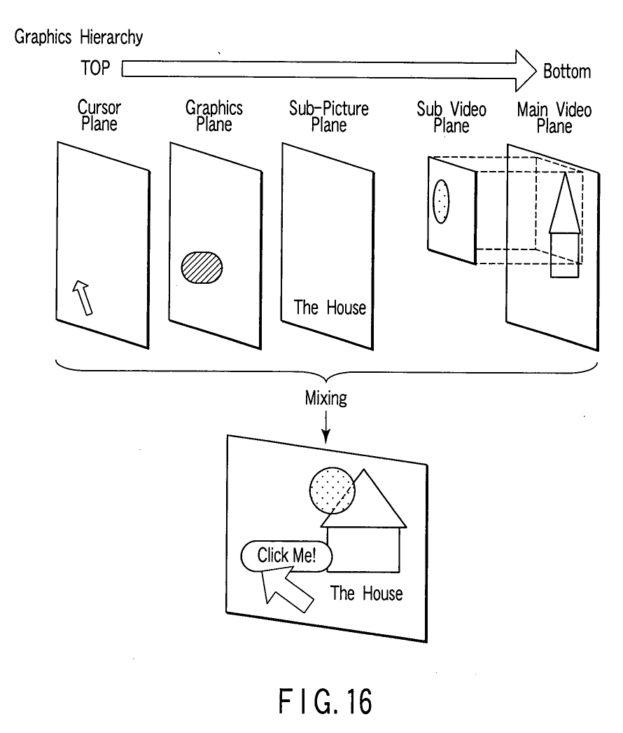

Video Mixing Model and Graphics Plane: The video mixing model is shown in FIG. 15. FIG. 16 shows a hierarchy of graphics planes.

Five graphics can be input to the model shown in FIG. 15. They are a cursor plane, a sub-picture plane, a sub-video plane, and a main video plane.

Cursor Plane: The cursor plane is the highest-order plane among the five graphics input to the graphic rendering engine of this model. The cursor plane is created by the cursor manager of the user interface manager. The cursor image can be replaced by the navigation manager according to the advanced navigation. The cursor manager moves the cursor to a suitable position on the cursor plane, thereby updating the cursor with respect to the graphic rendering engine. The graphic rendering engine acquires the cursor plane and alpha mix and lowers the plane according to alpha information from the navigation engine.

Graphics Plane: The graphics plane is the second plane among the five graphics input to the graphic rendering engine of this model. The graphics plane is created by an advanced element presentation engine according to the navigation engine. The layout manager uses the graphic decoder and text/font rasterizer to create a graphics plane. The size and rate of the output frame must be the same as those of the video output of this model. Animation effects can be realized by a series of graphic images (cell animations). The navigation manager of an overlay controller provides no alpha information to the present plane. These values are supplied to the alpha channel of the graphics plane itself.

Sub-Picture Plane: The sub-picture plane is the third plane among the five graphics input to the graphic rendering engine of this model. The sub-picture plane is created by the timed text decoder or sub-picture decoder of the decoder engine. A suitable sub-picture image set of the output frame size can be put in the primary video set. When a suitable size of an SP image is known, an SP decoder transmits the created frame image directly to the graphic rendering engine. When a suitable size of an SP image is unknown, a scaler following the SP decoder measures the suitable size and position of the frame image and transmits the results to the graphic rendering engine.

The secondary video set can include an advanced subtitle for the timed text decoder. The output data from the sub-picture decoder holds alpha channel information.

Sub-Video Plane: The sub-video plane is the fourth plane among the five graphics input to the graphic rendering engine of this model. The sub-video plane is created by the sub-video decoder of the decoder engine. The sub-video plane is measured by the scaler of the decoder engine on the basis of the information from the navigation manager. The output frame rate must be the same as that of the final video output. If information has been given, the clipping of the object shape of the sub-video plane is done by a chroma effect module of the graphic rendering engine. Chroma color (or range) information is supplied from the navigation manager according to the advanced navigation. The output plane from the chroma effect module has two alpha values: one is when the plane is 100% visible and the other is when the plane is 100% transparent. As for the overlay for the main video plane at the bottom layer, an intermediate alpha value is supplied from the navigation manager. The overlaying is done by the overlay control module of the graphic rendering engine.

Main Video Plane: The main video plane is the plane at the bottom layer among the five graphics input to the graphic rendering engine of this model. The main video plane is created by the main video decoder of the decoder engine. The main video plane is measured by the scaler of the decoder engine oh the basis of the information from the navigation manager. The output frame rate must be the same as that of the final video output. When the navigation manager has made a measurement according to the navigation, an outer frame color can be set to the main video plane. The default color value of the outer frame is “0, 0, 0” (=black).

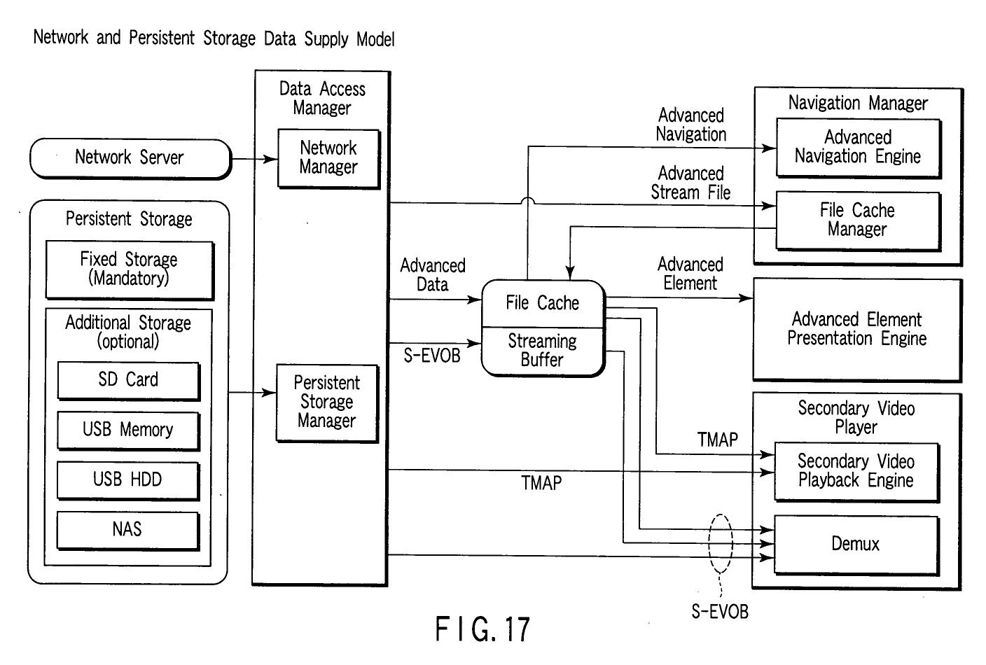

As described above, the advanced player selects a video-audio clip according to the object mapping of the playlist and reproduces the objects included in the clip using the timeline as the time base. Specifically, according to the description of the playlist, the first application is executed, referring to the primary/secondary video sets, if they are. One application is composed of a manifest, a markup (including content/styling/timing information), a script, and advanced data. The first markup file, script file, and other resources constituting an application are referred to in one manifest file. According to the markup, the reproduction of advanced data, such as the primary/secondary video sets, and advanced elements is started.

<Network and Persistent Storage Data Supply Model (FIG. 17)>

A network and persistent storage data supply model in FIG. 17 shows a data supply model for advanced contents from a network server and a persistent storage.

The network server and persistent storage can store all of the advanced content files excluding the primary video sets. The network manager and persistent storage manager provide a file access function. The network manager further provides an access function at the protocol level.

The file cache manager of the navigation manager can acquire an advanced stream file (in the archive format) directly from the network server and persistent storage via the network manager and persistent storage manager. The advanced navigation engine cannot access the network server and persistent storage directly. The file has to be immediately stored in the file cache before the advanced navigation engine reads the file.

The advanced element presentation engine can process a file in the network server or persistent storage. The advanced element presentation engine reads the file cache manager and acquires a file not in the file cache. The file cache manager makes a comparison with a file cache table, thereby determining whether the requested file has been cached in the file cache. If the file exists in the file cache, the file cache manager hands over the file data to the advanced presentation engine directly. If the file does not exist in the file cache, the file cache manager acquires the file from the original place into the file cache and hands over the file data to the advanced presentation engine.

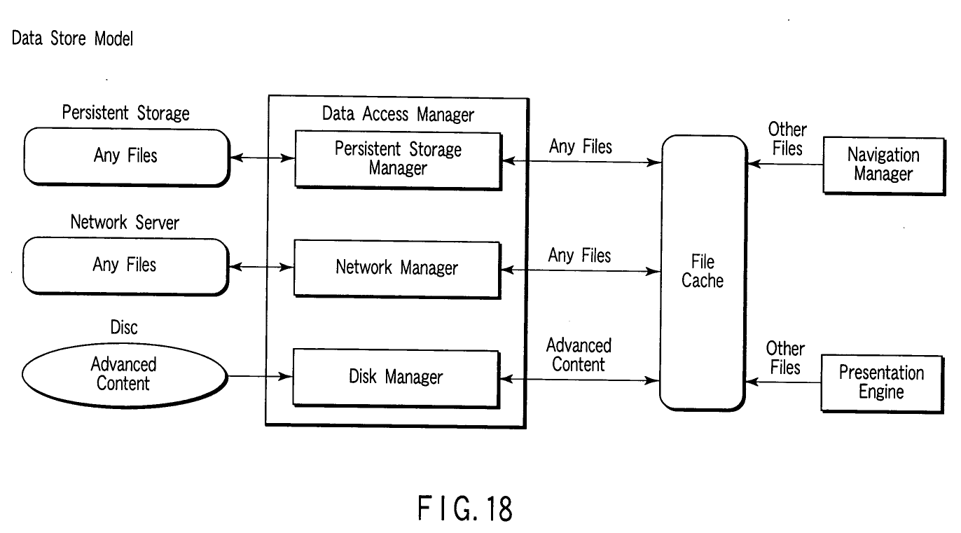

Like the file cache, the secondary video player acquires a secondary video set file, such as TMAP or S-EVOB, from the network server and persistent storage via the network manager and persistent storage manager. Generally, using the streaming buffer, the secondary video playback engine acquires S-EVOB from the network server. The secondary video playback engine stores part of S-EVOB data into the streaming buffer and supplies it to the demultiplexer module of the secondary video player.

<Date Store Model (FIG. 18)>

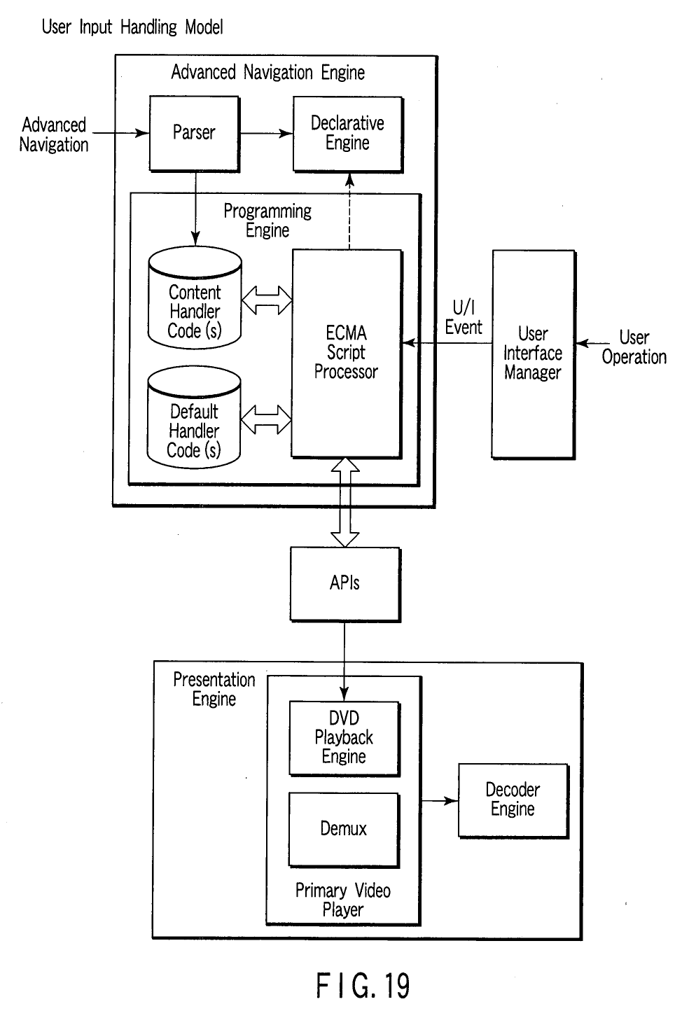

A data store model in FIG. 18 will be explained. There are two types of data storage: a persistent storage and a network server. When an advanced content is reproduced, two types of files are created. One is of an exclusive-use type and is created by the programming engine of the navigation manager. The format differs, depending on the description made by the programming engine. The other file is an image file and is collected by the presentation engine.

<User Input Model (FIG. 19)>

All user input events shown in FIG. 19 are handled by the programming engine. The user operation via the user interface device, such as the remote controller or front panel, is input to the user interface manager first. The user interface manager converts the input signal from each player into an event defined as “UIEvent” in “InterfaceRemoteControllerEvent”. The converted user input event is transmitted to the programming engine.

The programming engine has an ECMA script processor, which executes a programmable operation. The programmable operation is defined by the description of ECMA script provided by the script file of the advanced navigation. The user event handler code defined in the script file is registered in the programming engine.

When the ECMA script processor has received the user input event, the ECMA script processor checks whether the handler code corresponds to the present event registered in the content handler code. If it has been registered, the ECMA script processor executes it. If not, the ECMA script processor searches for a default handler code. If the corresponding default handler code exists, the ECMA script processor executes it. If not, the ECMA script processor either cancels the event or outputs a warning signal.

<Presentation Timing Model>

The advanced content presentation is managed using master time that defines a synchronous relationship between a presentation schedule and a presentation object. Master time is called title timeline. The title timeline, which is defined for each logical playback time, is called a title. A timing unit of the title timeline is 90 kHz. There are five types of presentation units: primary video set (PVS), secondary video set (SVS), auxiliary audio, auxiliary subtitle, and advanced application (ADV_APP).

<Presentation Object>

The five types of presentation objects are as follows:
Primary video set (PVS)
Secondary video set (SVS)
Sub-video/sub-audio
Sub-video
Sub-audio
Auxiliary audio (for primary video sets)
Auxiliary subtitle (for primary video sets)
Advanced application (ADV_APP)

<Attributes of Presentation Object>

A presentation object has two types of attributes: one is “scheduled” and the other is “synchronized”.

<Scheduled Presentation Object and Synchronized Presentation Object>

The beginning time and ending time of this object type are allocated to playlist files in advance. The presentation timing is synchronized with respect to the time of the title timeline. The primary video set, auxiliary audio, and auxiliary subtitle belong to this object type. Secondary video sets and advanced applications are treated as this object type.

<Scheduled Presentation Object and Unsynchronized Presentation Object>

The beginning time and ending time of this object type are allocated to playlist files in advance. The presentation timing is its own time base. Secondary video sets and advanced applications are treated as this object type.

<Unscheduled Presentation Object and Synchronized Presentation Object>

This object type is not written in the playlist file. This object is started up by a user event handled by the advanced application. The presentation timing is synchronized with respect to the title timeline.

<Unscheduled Presentation Object and Unsynchronized Presentation Object>

This object type is not written in the playlist file. This object is started up by a user event handled by the advanced application. The presentation timing is its own time base.

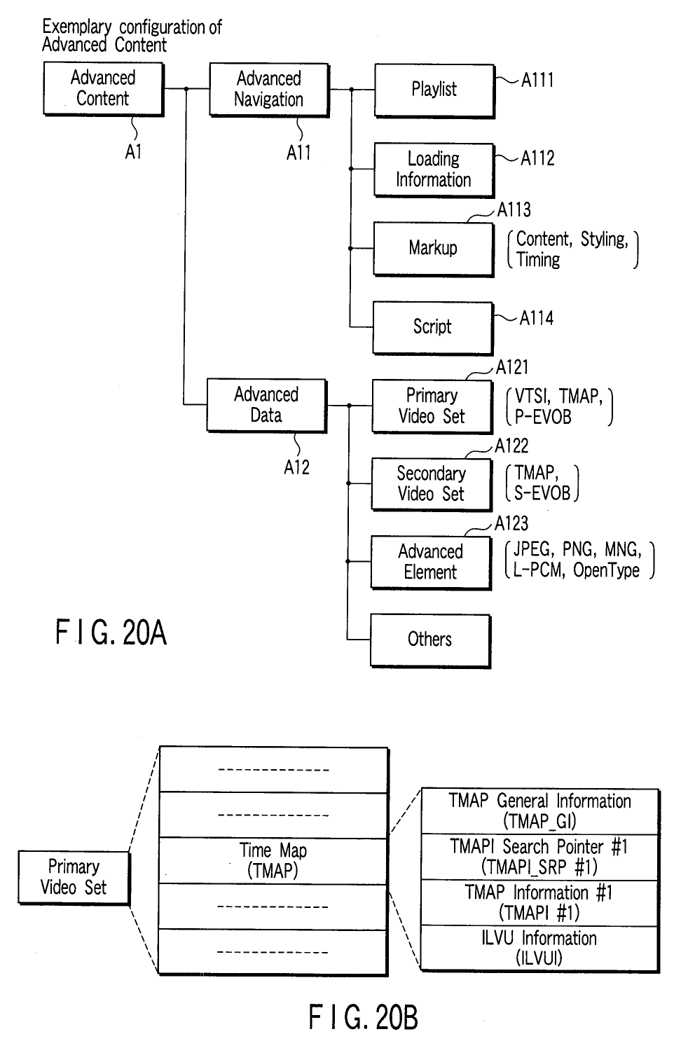

FIGS. 20A and 20B are diagrams to help explain a configuration of the advanced content stored in the advanced content recording area of the information storage medium. The advanced content is not necessarily stored in an information storage medium and may be supplied from, for example, a server via a network.

As shown in FIG. 20A, the advanced content recorded in an advanced content area A1 includes advanced navigation which manages primary/secondary video set output and text/graphic rendering and audio output, and advanced data composed of data managed by the advanced navigation. The advanced navigation recorded in the advanced navigation area A11 includes playlist files, loading information files, markup files (for content, styling, timing information), and script files. The playlist files are recorded in a playlist file area A111. The loading information files are recorded in a loading information file area A112. The markup files are recorded in a markup file area A113. The script files are recorded in a script file area A114.

The advanced data recorded in an advanced data area A12 includes primary video sets including object data (VTSI, TMAP and P-EVOB), secondary video sets including object data (TMAP and S-EVOB), advanced elements (JPEG, PNG, MNG, L-PCM, OpenType font, and the like), and others. In addition to these, the advanced data further includes object data constituting a menu (screen). For example, the object data included in the advanced data is reproduced in a specified period on the timeline according to the time map (TMAP) in the format shown in FIG. 20B. The primary video sets are recorded in a primary video set area A121. The secondary video sets are recorded in a secondary video set area A122. The advanced elements are recorded in an advanced element area A123.

The advanced navigation includes playlist files, loading information files, markup files (for content, styling, timing information), and script files. These files (playlist files, loading information files, markup files, and script files) are encoded as XML documents. If the resources of XML documents for advanced navigation have not been written in the correct format, they are rejected at the advanced navigation engine.

The XML documents become effective according to the definition of a reference document type. The advanced navigation engine (on the player side) does not necessarily require the function of determining the validity of contents (the provider should guarantee the validity of contents). If the resources of XML documents have not been written in the correct format, the proper operation of the advanced navigation engine is not guaranteed.

The following rules are applied to XML declaration:
Let encode declaration be “UTF-8” or “ISO-8859-1”. XML files are encoded on the basis of one of these.
Let the value of standard document declaration in XML declaration be set as “no” when the standard document declaration is present. If there is no standard document declaration, the value is regarded as “no”.

All of the resources usable on a disc or a network have addresses encoded by Uniform Resource Identifier defined in [URI, RFC2396].

The protocol and path supported for a DVD disc are as follows: for example,

file://dvdrom://dvd_advnav/file.xml

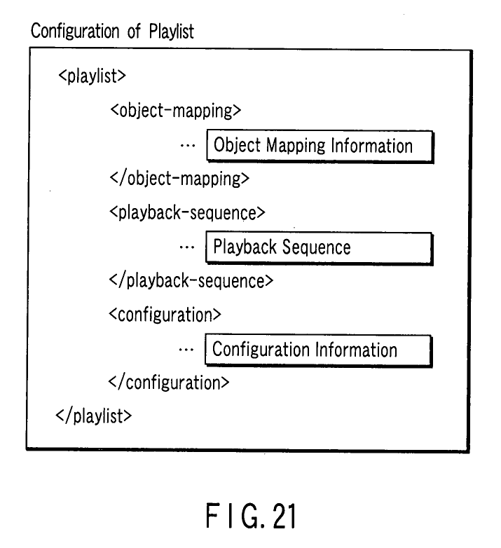

FIG. 20B shows a configuration of the time map (TMAP). As a component part, the time map has time map information (TMAPI) used to convert the playback time in a primary enhanced video object (P-EVOB) into the address of the corresponding enhanced video object unit (EVOBU). In TMAP, TMAP General Information (TMAP_GI), TMAPI Search Pointer (TMAPI_SRP), TMAP Information (TMAPI), and ILVU Information (ILVUI) are arranged in that order.

<Playlist File (FIG. 21)>

There are two intended uses of a playlist file in reproducing advanced contents. One is for an initial system configuration of the HD DVD player and the other is for the definition of a method of playing a plurality of presentation contents in the advanced content.

As shown in FIG. 21, in the playlist file, a set of object mapping information and the playback sequence for each title are written for each title.
Object mapping information (information on presentation objects mapped on the timeline in each title)
Playback sequence (playback information for each title written according to the timeline of the title)
Configuration information (information for system configuration, such as data buffer alignment)

The playlist file is encoded in the XML format. The syntax of the playlist file can be defined by an XML syntax representation.

On the basis of a time map for reproducing a plurality of objects in a specified period on the timeline, the playlist file controls the playback of menus and titles composed of, for example, these objects. The playlist enables the menus to be played back dynamically.

With the menu linked with the time map, it is possible to give the user dynamic information. For example, on the menu liked with the time map, a reduced-size playback screen (moving image) for each chapter constituting a title can be displayed. This makes it relatively easy to distinguish the individual chapters constituting a title with many similar scenes. That is, the menu linked with the time map enables a multilateral display, which makes it possible to realize a complex, impressive menu display.

<Elements and Attributes>

A playlist element is a root element of the playlist. An XML syntax representation of a playlist element is, for example, as follows:

<Playlist>
Configuration TitleSet
</Playlist>

A playlist element is composed of a TitleSet element for a set of information on Titles and a configuration element for system configuration information. The configuration element is composed of a set of system configuration for advanced content. The system configuration information may be composed of, for example, data cache configuration specifying a stream buffer size and the like.

A title set element is for describing information on a set of Titles for Advanced Contents in the playlist. An XML syntax representation of the title set element is, for example, as follows:

<TitleSet>
Title*
</TitleSet>

A title set element is composed of a list of Title elements. Advanced navigation title numbers are allocated sequentially in the order of documents in the title element, beginning at “1”. The title element is configured to describe information on each title.

Specifically, the title element describes information about a title for advanced contents which includes object mapping information and a playback sequence in the title. An XML syntax representation of the title element is, for example, as follows:

```
<Title
    id = ID
    hidden = (true | false)
    onExit = positiveInteger>
        Primary Video Track?
        SecondaryVideoTrack ?
        SubstituteAudioTrack ?
        ComplementarySubtitleTrack ?
        ApplicationTrack *
        Chapter List ?
</Title>
```

The content of a title element is composed of an element fragment for tracks and a chapter list element. The element fragment for tracks is composed of a list of elements of a primary video track, a secondary video track, a SubstituteAudio track, a complementary subtitle track, and an application track.

Object mapping information for a title is written using an element fragment for tracks. The mapping of presentation objects on the title timeline is written using the corresponding element. Here, a primary video set corresponds to a primary video track, a secondary video set corresponds to a secondary video track, a SubstituteAudio corresponds to a SubstituteAudio Track, a complementary subtitle corresponds to a complementary subtitle track, and ADV_APP corresponds to an application track.

The title timeline is allocated to each title. Information on a playback sequence for a title composed of chapter points is written using chapter list elements.

Here, (a) hidden attribute makes it possible to write whether the title can be navigated by the user operation. If its value is “true”, the title cannot be navigated by the user operation. The value may be omitted. In that case, the default value is “false”.

Furthermore, (b) on Exit attribute makes it possible to write a title to be reproduced after the playback of the present title. When the playback of the present title is earlier than the ending of the title, the player can be configured not to jump the playback.

A primary video track element is for describing object mapping information on the primary video set in the title. An XML syntax representation of the primary video track element is, for example, as follows:

```
<Primary Video Track
    id = ID>
        (Clip | Clip Block) +
</Primary Video Track>
```

The content of a primary video track is composed of a list of clip elements and clip block elements which refer to P-EVOB in the primary video as presentation objects. The player is configured to preassign P-EVOBs onto the title timeline using a start time and an end time according to the description of the clip element. The P-EVOBs allocated onto the title timeline are prevented from overlapping with one another.

A secondary video track element is for describing object mapping information on the secondary video set in the title. An XML syntax representation of the secondary video track element is, for example, as follows:

```
<Secondary Video Track
    id = ID>
      sync = (true | false)>
        Clip +
</Secondary Video Track>
```

The content of a secondary video track is composed of a list of clip elements which refer to S-EVOB in the secondary video set as presentation objects. The player is configured to preassign S-EVOBs onto the title timeline using a start time and an end time according to the description of the clip element.

Furthermore, the player is configured to map clips and clip blocks onto the title timeline as a start and an end position of the clip on the title timeline on the basis of the title begin time and title end time attribute of the clip element. The S-EVOBs allocated onto the title timeline are prevented from overlapping with one another.

Here, if a sync attribute is “true”, the secondary set is synchronized with time on the title timeline. If a sync attribute is “false”, the secondary video set can be configured to run on its own time (in other words, if the sync attribute is “false”, playback progresses at the time allocated to the secondary video set itself, not at the time on the timeline).

Furthermore, if the sync attribute value is “true” or omitted, the presentation object in the secondary video track becomes a synchronized object. If the sync attribute value is “false”, the presentation object in SecondaryVideoTrack becomes an unsynchronized object.

A SubstituteAudioTrack element is for describing object mapping information on a substitute audio track in the title and the assignment of audio stream numbers. An XML syntax representation of the substitute audio track element is, for example, as follows:

```
<SubstituteAudioTrack
    id = ID
    streamNumber = Number
            languageCode = token
            >
        Clip +
</SubstituteAudioTrack>
```

The content of a SubstituteAudioTrack element is composed of a list of clip elements which refer to SubstituteAudio as a presentation element. The player is configured to preassign SubstituteAudio onto the title timeline according to the description of the clip element. The SubstituteAudios allocated onto the title timeline are prevented from overlapping with one another.

A specific audio stream number is allocated to SubstituteAudio. If Audio_stream_Change API selects a specific stream number of SubstituteAudio, the player is configured to select SubstituteAudio in place of the audio stream in the primary video set.

In a stream number attribute, the audio stream number for SubstituteAudio is written.

In a language code attribute, a specific code for SubstituteAudio and a specific code extension are written.

A language code attribute value follows the following scheme (BNF scheme). Specifically, in the specific code and specific code extension, a specific code and a specific code extension are written respectively. For example, they are as follows:

languageCode := specificCode
specificCode := [A–Za–z][A–Za–z0–9]
specificCodeExt := [0–9A–F][0–9A–F]

A complementary subtitle track element is for describing object mapping information on a complementary subtitle in the title and the assignment of sub-picture stream numbers. An XML syntax representation of the complementary subtitle track element is, for example, as follows:

```
<ComplementarySubtitleTrack
    id = ID
    streamNumber = Number
            languageCode = token
            >
        Clip +
</ComplementarySubtitleTrack>
```

The content of a complementary subtitle element is composed of a list of clip elements which refer to a complementary subtitle as a presentation element. The player is configured to preassign complementary subtitles onto the title timeline according to the description of the clip element. The complementary subtitles allocated onto the title timeline are prevented from overlapping with one another.

A specific sub-picture stream number is allocated to the complementary subtitle. If Sub-picture_stream_Change API selects a stream number for the complementary subtitle, the player is configured to select a complementary subtitle in place of the sub-picture stream in the primary video set.

In a stream number attribute, the sub-picture stream number for the complementary subtitle is written.

In a language code attribute, a specific code for the complementary subtitle and a specific extension are written.

A language code attribute value follows the following scheme (BNF scheme). Specifically, in the specific code and specific code extension, a specific code and a specific code extension are written respectively. For example, they are as follows:

languageCode := specificCode
specificCode := [A–Za–z][A–Za–z0–9]
specificCodeExt := [0–9A–F][0–9A–F]

An application track element is for describing object mapping information on ADV_APP in the title. An XML syntax representation of the application track element is, for example, as follows:

```
<ApplicationTrack
    id = ID
    loading_info = anyURI
    sync = (true | false)
    language = string/>
```

Here, ADV_APP is scheduled on the entire title timeline. When starting the playback of the title, the player starts ADV_APP on the basis of loading information shown by the loading information attribute. If the player stops the playback of the title, ADV_APP in the title is also terminated.

Here, if the sync attribute is “true”, ADV_APP is configured to be synchronized with time on the title timeline. If the sync attribute is “false”, ADV_APP can be configured to run at its own time.

Loading information attribute is for describing URI for a loading information file in which initialization information on the application has been written.

If the sync attribute value is “true”, this means that ADV_APP in ApplicationTrack is a synchronized object. If the sync attribute value is “false”, this means that ADV_APP in ApplicationTrack is an unsynchronized object.

A clip element is for describing information on the period (the life period or the period from the start time to end time) on the title timeline of the presentation object. An XML syntax representation of the clip element is, for example, as follows:

```
    <Clip
        id = ID
        title Time Begin = time Expression
        clip Time Begin = time Expression
        title Time End = time Expression
        src = anyURI
        preload = time Expression
        xml:base = anyURI >
            (Unavailable Audio Stream |
Unavailable Sub picture Stream )*
    </Clip>
```

The life period on the title timeline of the presentation object is determined by the start time and end time on the title timeline. The start time and end time on the title timeline can be written using a title Time Begin attribute and a title Time End attribute, respectively. The starting position of the presentation object is written using a clip Time Begin attribute. At the start time on the title timeline, the presentation object is in the start position written using a clip Time Begin.

The presentation object is referred to using URI of the index information file. For a primary video set, the P-EVOB TMAP file is referred to. For a secondary video object, the S-EVOB TMAP file is referred to. For SubstituteAudios and complementary subtitles, the S-EVOB TMAP file in the secondary video set including objects is referred to.

The attribute values of title Begin Time, title End Time, clip Begin Time, and presentation object duration are configured to satisfy the following relationship:

```
    title Begin Time < title End Time and
    Clip Begin Time + title End Time − title Begin
Time
            ≦ Presentation Object [symbol]  duration
time
```

Unusable audio streams and unusable sub-picture streams are present only for the clip elements in a preliminary video track element.

A title Time Begin attribute is for describing a start time of a continuous fragment of a presentation object on the title timeline.

A title Time End attribute is for describing an end time of the continuous fragment of the presentation object on the title timeline.

A clip Time Begin attribute is for describing a starting position in the presentation object. Its value can be written in the time Expression value. The clip Time Begin may be omitted. If there is no clip Time Begin attribute, let the starting position be, for example, “0”.

An src attribute is for describing URI of an index information file of presentation objects to be referred to.

A preload attribute is for describing time on the title timeline in staring the reproduction of a presentation object fetched in advance by the player.

A clip block element is for describing a group of clips in P-EVOBS called a clip block. One clip is selected for playback. An XML syntax representation of a clip block element is, for example, as follows:

<Clip Block>
Clip+
</Clip Block>

All of the clips in the clip block are configured to have the same start time and the same end time. For this reason, the clip block can do scheduling on the title timeline using the start time and end time of the first child clip. The clip block can be configured to be usable only in a primary video track.

The clip block can represent an angle block. In the order of documents in the clip element, advanced navigation angle numbers are allocated consecutively, beginning at “1”.

The player selects the first clip to be reproduced as a default. However, if Angle_Change API has selected a specific angle number, the player selects a clip corresponding to it as the one to be reproduced.

The unusable audio stream elements in a clip element that describes a decoding audio stream in P-EVOBS is configured to be unusable during the reproduction of the clip. An XML syntax representation of an unusable audio stream element is, for example, as follows:

```
<Unusable Audio Stream
        number = integer
        />
```

An unusable audio stream element can be used only in a P-EVOB clip element in the primary video track element. Otherwise, any unusable audio stream is caused to be absent. The player disables the decoding audio stream shown by the number attribute.

An unusable sub-picture stream element in a clip element that describes a decoding sub-picture stream in P-EVOBS is configured to be unusable during the reproduction of the clip. An XML syntax representation of an unusable sub-picture stream element is, for example, as follows:

```
<Unusable Sub-picture Stream
    number = integer
    />
```

An unusable sub-picture stream element can be used only in P-EVOB clip elements in the primary video track element. Otherwise, any unusable sub-picture stream is caused to be absent. The player disables the decoding sub-picture stream shown by the number attribute.

A chapter list element in the title element is for describing playback sequence information for the title. The playback sequence defines the chapter start position using a time value on the title timeline. An XML syntax representation of a chapter list element is, for example, as follows:

```
<Chapter List>
                Chapter+
                /Chapter List>
```

A chapter list element is composed of a list of chapter elements. A chapter element describes the chapter start position on the title timeline. In the order of documents in a chapter element in the chapter list, the advanced navigation chapter numbers are allocated consecutively, beginning at “1”. Specifically, the chapter positions on the title timeline are configured to monotonically increase according to the chapter numbers.

A chapter element is for describing the chapter start position on the title timeline in the playback sequence. An XML syntax representation of a chapter element is, for example, as follows:

```
<Chapter
        id = ID
        title Begin Time = time Expression/>
```

A chapter element has a title Begin Time attribute. The time Expression value of the title Begin Time attribute is for describing the chapter start position on the title timeline.

The title Begin Time attribute is for describing the chapter start position on the title timeline in the playback sequence. Its value is written in the time Expression value.

<Datatypes>

time Expression is for describing time code in integers in units of, for example, 90 kHz.

[About loading information files]

A loading information file is for title ADV_APP initial information. The player is configured to start ADV_APP on the basis of the information in the loading information file. The ADV_APP has a configuration composed of the presentation of Markup file and the execution of Script.

Pieces of initial information written in the loading information file are as follows:
Files to be first stored in the file cache before the execution of an initial markup file
Initial markup file to be executed
Script file to be executed

A loading information file has to be encoded in the correct XML form. The rules for XML document files are applied to the loading information file.

<Elements and Attributes>

The syntax of a loading information file is determined using an XML syntax representation.

An application element is the root element of a loading information file and includes the following elements and attributes:

XML syntax representation of an application element:

```
    <Application
            Id = ID
            >
                Resource* Script ? Markup ?
Boundary ?
    </Application>
```

A resource element is for describing files to be stored in the file cache before the execution of the initial markup. An XML syntax representation of a playlist element is, for example, as follows:

```
<Resource
        id = ID
        src = anyURI
        />
```

Here, the src attribute is for describing URI of a file stored in the file cache.

A script element is for describing an initial script file for ADV_APP. An XML syntax representation of a script element is, for example, as follows:

```
<Script
        id = ID
        src = anyURI
        />
```

At the start-up of an application, the script engine loads a script file to be referred to using URI in the scr attribute and executes the loaded file as global code [ECMA 10.2.10]. The src attribute describes URI for initial script files.

A markup element is for describing an initial markup file for ADV_APP. An XML syntax representation of a markup element is, for example, as follows:

```
<Markup
        id = ID
        src = anyURI
        />
```

At the start-up of an application, if there is an initial script file, the advanced navigation refers to URI in the src attribute after the execution of the initial script file, thereby loading a markup file. Here, the src attribute describes URI for the initial markup file.

A boundary element can be configured to describe effective URL to which an application can refer.

<About Markup Files>

A markup file is information on presentation objects on the graphic plane. The number of markup files which can exist at the same time in an application is limited to one. A markup file is composed of a content model, styling, and timing.

<About Script Files>

A script file is for describing script global codes. The script engine is configured to execute a script file at the start-up of ADV_APP and wait for an event in an event handler defined by the executed script global code.

Here, the script is configured to be capable of controlling the playback sequence and graphics on the graphics plane according to an event, such as a user input event or a player playback event.

<Playlist File: written in XML (markup language)>

A reproducing unit (or player) is configured to reproduce the playlist file first (before reproducing advanced contents), when the disc has advance contents.

The primary video set is composed of Video Title Set Information (VTSI), Enhanced Video Object Set for Video Title Set (VTS_EVOBS), Backup of Video Title Set Information (VTSI_BUP), and Video Title Set Time Map Information (VTS_TMAPI).

Several of the following files can be stored in an archive without compression:
Manifest (XML)
Markup (XML)
Script (ECMAScript)
Image (JPEG/PNG/MNG)
Sound effect audio (WAV)
Font (OpenType)
Advanced subtitle (XML)

In this standard, a file stored in the archive is called an advanced stream. The file can be stored (under the ADV_OBJ directory) on a disc or delivered from a server. The file is multiplexed with EVOB in the primary video set. In this case, the file is divided into packs called advanced packs (ADV_PCK).

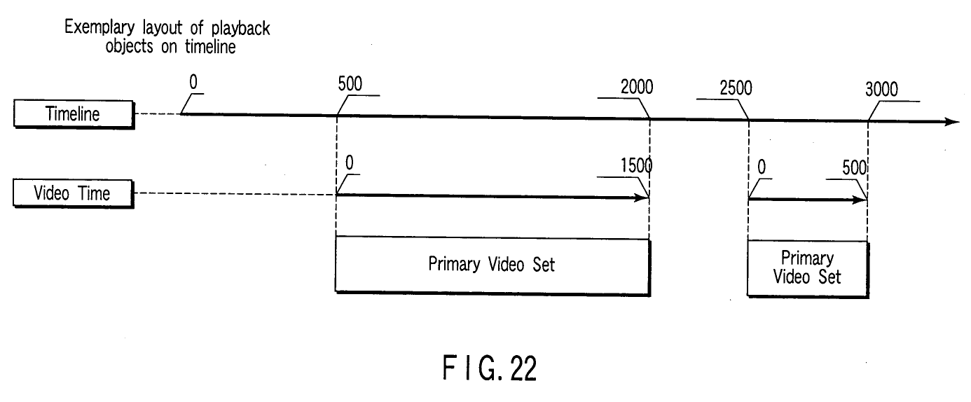

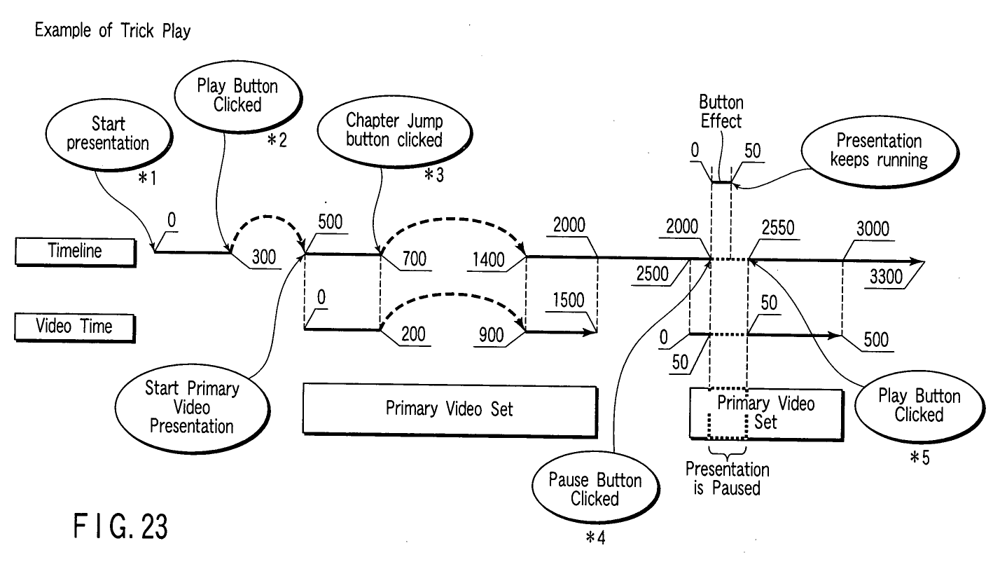

FIGS. 22 and 23 are diagrams to help explain the timeline used in the playlist. FIG. 22 shows an example of the allocation of presentation objects on the timeline. As units of timeline, video frames, seconds (milliseconds), clocks with a base of 90 kHz/27 MHz, units determined in the SMPTE can be used. In the example of FIG. 22, there are prepared two primary video sets with time lengths of 1500 and 500, respectively. They are arranged in the range of 500 to 1500 and in the range of 2500 to 3000 on the timeline serving as a time axis. Objects with their own time lengths are arranged on the timeline, a time axis, which enables each object to be reproduced without contradiction. The timeline can be configured to be reset to zero for each playlist used.

FIG. 23 is a diagram to help explain a case where a trick play (such as a chapter jump) of a presentation object is made on the timeline. FIG. 23 shows an example of the way time advances on the timeline when a playback operation is actually carried out. Specifically, when playback is started, time on the timeline progresses *1. When “Play” button is pressed at time 300 on the timeline *2, time on the timeline is caused to jump to 500, thereby starting the playback of a primary video set. Thereafter, at time 700, when “Chapter Jump” button is pressed *3, time is caused to jump to the starting position of the corresponding chapter (here, time 1400 on the timeline), from which playback is started. Thereafter, “Pause” button is pressed at time 2550 (by the user of the player)*4, which produces a button effect. Then, the playback pauses. When “Play” button is clicked at time 2550 *5, playback is resumed.

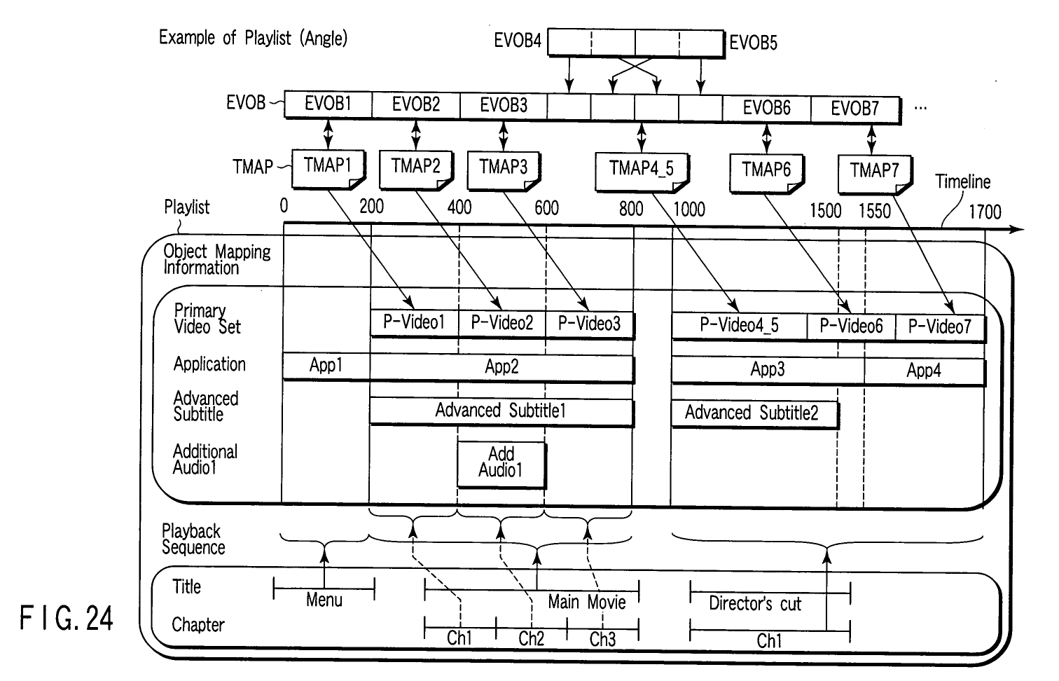

FIG. 24 shows an example of the playlist when EVOB has an interleaved angle. Although EVOB has the corresponding TMAP files, interleaved angle blocks EVOB4 and EVOB5 have information written in the same TMAP file. By specifying the individual TMAP files in the object mapping information, primary video sets are mapped on the timeline. Moreover, according to the description of the object mapping information in the playlist, applications, advanced subtitles, additional audios, and others are mapped on the timeline.

In FIG. 24, a title with no video (such as menu in use) has been defined between time 0 to time 200 on the timeline as application 1. Moreover, in the period between time 200 and time 800, application 2, primary videos 1 to 3, advanced subtitle 1, and additional audio 1 have been set. In the period between time 1000 and time 1700, primary video 4_5 composed of EVOB4 and EVOB5 constituting an angle block, primary video 6, primary video 7, applications 3 and 4, and advanced substitute 2 have been set.

Furthermore, in the playback sequence, App1 defines menu as a title, App2 defines main movie as a title, and App3 and App4 define the configuring of director's cut. In addition, three chapters have been defined in the main movie and one chapter has been defined in the director's cut.

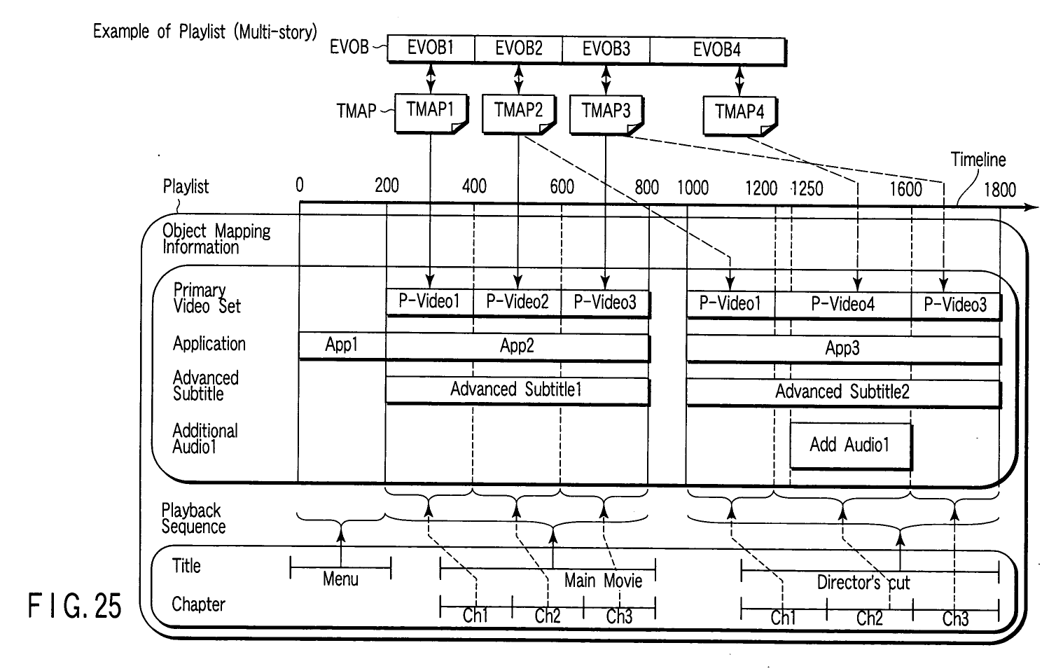

FIG. 25 is a diagram to help explain an example of the configuration of the playlist when an object includes a multi-story. FIG. 25 is a view of the playlist when a multi-story is set. By specifying TMAP in the object mapping information, these two titles are mapped on the timeline. In the example, EVOB1 and EVOB3 are used in both titles and EVOB2 and EVOB4 are replaced with each other, thereby enabling a multi-story.

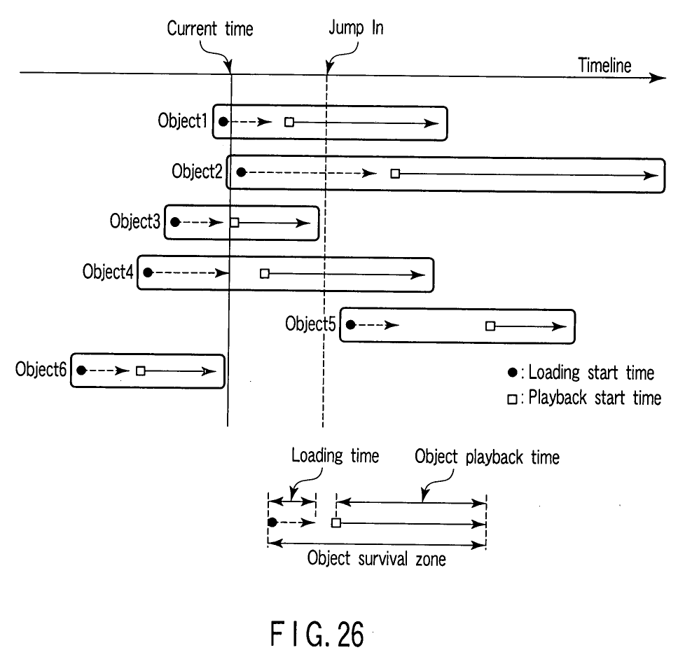

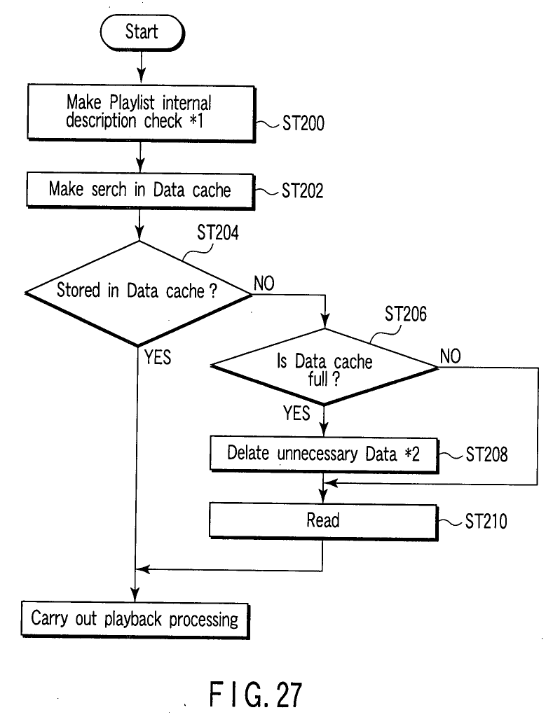

The playlist will be explained further. FIGS. 26 and 27 are diagrams to help explain the playlist.

In the playlist, not only the playback time but also the load time is written. Writing read time in the playlist enables the usage of the data cache to be measured (or detected). Using the result of measuring (or detecting) the usage of the data cache makes it possible to create contents efficiently at the time of authoring. Moreover, holding objects that may not be deleted in the data cache enables the performance of the player to be improved. This will be explained below.

FIG. 26 shows an example of the playback time and load start time of each object on the timeline. In FIG. 26, when a jump is made from the present time shown by a straight line to the place shown by a dotted line, since Object 3 and Object 6 have already been played back, there is no need to take them into account.

Furthermore, since the load start time of Object 5 has not been reached, there is no need to take it into account. The loading of Object 1 has been started and not ended at the present time. Since Object 1 is being played back at the jump destination, the same content as Object 1 in another file is loaded and played back. Since Object 2 has jumped to the middle of loading, it is played back after the loading has been finished at least as much as corresponds to the jump destination since the load start time.

Since a jump has been made at the time when the loading of Object 4 has been completed, the data cache is searched for Object 4. If its existence has been confirmed, it is played back. This is realized by adding a Loadstart attribute to the description of the playlist.

FIG. 27 is a flowchart corresponding to the above process. When a jump operation has been carried out, the description of the playlist is checked (step ST200) to search the data cache for an object (step ST202). If an object has been stored in the data cache (Yes in step ST204), the playback is performed using the object.

If no object has been stored in the data cache (No in step ST204), a check is made to see if the data cache has room to store (step ST206). If the data cache is full (Yes in step ST206), an unnecessary object is deleted (step S208) and necessary data is read from a prepared file into the data cache (step ST210), thereby performing the playback.

If the data cache has room to store (No in step ST206), the necessary data is read into the data cache without deleting the object from the data cache (step ST210), followed by the playback. By not deleting the stored content, the content stored in the data cache can be searched for and used, when the content is needed again in, for example, a jump operation. As described above, making the capacity of the data cache sufficiently large makes it possible to improve the capability of the player. This helps differentiate the devices from one another.

Furthermore, since the usage of the data cache for each time can be calculated (by adding the Loadstart attribute to the playlist), still another object can be set when there is room for the capacity of the data cache in creating contents, which enables contents to be created efficiently.

The management of the playlist can be performed by the playlist manager in the navigation manager.

In the file cache manager, a file system has been prepared. According to the playlist, the file system manages the files or the archived files or archived data stored in the file cache. Specifically, by request of the navigation manager, presentation engine, advanced element engine, or data access manager, the writing and reading of the files in the file cache are controlled. The file cache, which is a part of the data cache, is used as a place for storing files temporarily.

First, the file cache is defined so as to have a storage area of 64 MB (megabytes) minimum. Defining the minimum capacity of the file cache enables the provider to design the contents of a recording medium and the capacity of the management information. In the file cache, the size of one memory block is set to 512 bytes. The block size is set as a consumption unit. Even if a 1-byte file has been written, 512 bytes are allocated and consumed. Accessing data in units of 512 bytes enables easy, high-speed accessing to be done. Moreover, address management is also easy.

The file cache can deal with unarchived files and archived data in which a plurality of files have been archived. In the name of archived data, a file name is represented by eight characters and the extension is represented by three characters. In the disc, a unique file name is used. The name of the file in the archived data is expressed using 32 bytes (including the extension). The maximum file size is 64 MB. The maximum number of files is determined to be 2000 on the disc and 2000 in the archive.

Resources are managed on the basis of the following pieces of information: they are mapping information on the title timeline (title time axis) written in the resource information managed by the playlist manager and the file list and delete list written in the resource management table managed by the file cache manager.

When the application programming interface (API) accesses data, the data under the control of the playlist manager is read-only data. The files in a temporary directory (Temp directory) prepared as an API directory can be read from and written into.

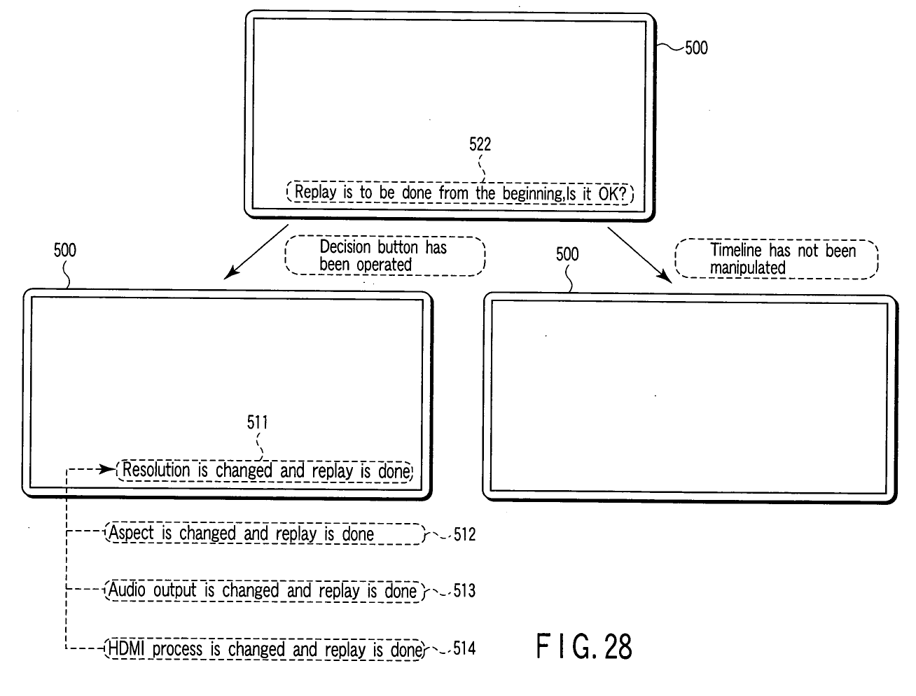

FIG. 28 shows an example of comments displayed on a display unit 500 connected to the apparatus when the aspect, resolution, audio output, or output mode has been changed. These comment information outputs are obtained by controlling the graphic decoder of the reproducing section by the graphic interface controller (GUI controller) 141.

For example, when the resolution change button is operated through the remote controller, while a disc in which advanced contents have been recorded is playing back, a comment 511 (e.g., “The resolution is changed and replaying is done”) is displayed on the screen. With this comment, the user recognizes that the resolution has been changed and does not mistake the display for a malfunction even if the player does a replay from the beginning. Moreover, when the aspect change button has been operated, a comment 512 is displayed. When the operation of changing the audio output mode (such as the number of output channels or the mixed form) has been carried out, a comment 513 is displayed. When the setting of the HDMI process has been changed, a comment 514 is displayed.

A comment 522 may be displayed, for example, 20 minutes, 30 minutes, or 40 minutes after the playback of the advanced content was started. This setting can be done, for example, on the menu screen. Furthermore, when the decision button on the remote controller has not been pressed for one minute or within 30 seconds since the comment 522 was displayed, the present playback state is maintained.

The setting change process is carried out by giving an instruction to change the system parameters in the memory 140. As the system parameters, for example, the various parameters described below are used.

The parameters are classified into, for example, various tables. In table W1, the player parameters are written. They are set in each player. In table W2, the capability parameters are written. These parameters show the video, audio, and network capabilities of the player. In table W3, the presentation parameters are written. These parameters are used to set the playback state. Table W7 has the system parameters. Some examples of the tables will be described below. Selecting such system parameters enables the setting of the processing mode in the reproducing section to be changed.

[W1]

MajorVersion=00000001 (with major version information support)

MinorVersion=00000000 (without minor version information support)

DisplayMode=00000003 (with display mode support)

SizeofDataCache=67108864 (size value of data cache)

PerformanceLevel=00000001 (with performance level setting)

ClosedCaption=00000001 (with closed caption support)

SimplifiedCaption=0000.0000 (without simplified caption support)

LargeFont=00000000 (without support of large chapter size)

ContrastDisplay=00000000 (without contrast display support)

DescriptiveAudio=00000000 (without audio description support)

ExtendedInteractionTimes=0000000 (without extended interaction time setting)

[W2]

EnableHDMIOutput=00000000 (without HDMI output support)

LinearPCMSupportofMainAudio=00000002 (main audio with linear PCM support)

DDPlusSupportofMainAudio=00000002 (main audio with Dolby digital plus support)

MPEG AudioSupportofMainAudio=00000001 (main audio with MPEG audio support)

DTSHDSupportofMainAudio=00000002 (main audio with DTS support in HD)

MLPSupportofMainAudio=00000001 (main audio with MLP support)

DDPlusSupportofSubAudio=00000001 (sub-audio with Dolby digital plus support)

DTSHDSupportofSubAudio=00000001 (sub-audio with DTS support in HD)

MPEG-4HEAACv2SupportofSubAudio=00000000

mp3SupportofSubAudio=00000000

WMAProSupportofSubAudio=00000000

SupportofAnalogAudioOutput=00000002 (with analog audio output support)

SupportofHDMI=00000002 (with HDMI support)

SupportofSPDIF=00000002 (with S/PDIF support)

EncodingSupportofSPDIF=00000001 (with encode S/PDIF support)

DirectOutputtoSPDIFofDolbyDigital=00000001 (with support of the direct output of digital Dolby to S/PDIF)

DirectOutputtoSPDIFofDTS=00000001 (with support of the direct output of DTS to S/PDIF)

ResolutionofSubVideo=00000001 (with support of the setting of resolution of sub-video)

NetworkConnection=00000001 (with support of network connection)

NetworkThroughout=00000000

SupportofOpenTypeFontTables=00000001 (with support of open-type font tables)

SupportofSlowForward=00000001 (with support of low-speed playback)

SupportofSlowReverse=00000000

SupportofStepForward=00000001

SupportofStepReverse=00000000

[W3]

SelectedAudioLanguageCode=“EN” (English language code in selected audio)

SelectedAudioLanguageCode Exension=00000000

SelectedSybtitleLanguageCode=“EN” (English language code in selected subtitle)

SelectedSubtitleLanguageCodeExtension=

[W7]

MenuLanguage=“EN” (English as the menu language)

CountryCode=“US”) (United States as country code)

ParentalLevel=00000000

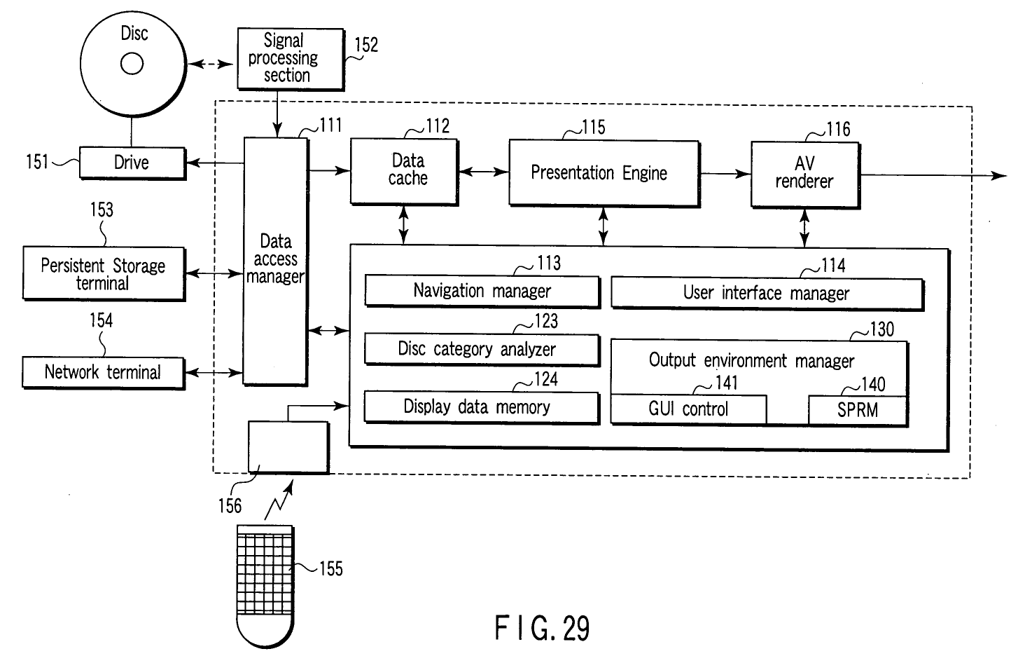

FIG. 29 shows a simplified block diagram of the entire player. The data recorded on the disc can be loaded via a signal processing section 152 into the data access manager 111. A drive 151 rotates the disc and performs tracking and focusing control. Moreover, the data in the persistent storage can be loaded via a persistent storage terminal 153 into the data access manager 111. The data in the network server can be loaded via a network terminal 154 into the data access manager 111. The operation signal from a remote controller 155 is supplied via a control signal receiving section 156 to the user interface manager 114. Hereinafter, the parts corresponding to those of the configuration of FIG. 14 are indicated by the same reference numerals as those in FIG. 14 and an explanation of them will be omitted.

This invention is not limited to the above embodiments and may be embodied by modifying the component elements without departing from the spirit or essential character thereof. In addition, various inventions may be formed by combining suitably a plurality of component elements disclosed in the embodiments. For example, some components may be removed from all of the component elements constituting the embodiments. Furthermore, component elements used in different embodiments may be combined suitably.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing apparatus comprising:
a reproducing section which reproduces contents on the basis of playback management information in order to reproduce the contents of a disc;
a continuation control section which changes the setting of the reproducing section according to output setting information and causes the reproducing section to continue the reproduction, when any one of aspect, resolution, and audio used as the output setting information has been changed in the middle of reproducing a first content of the disc; and
a graphic user interface control section which outputs a comment to the effect that a replay state starts at an object starting position, when the change of any one of aspect, resolution, and audio used as the output setting information is input a specific time after the start of the reproduction of a second content of the disc.

2. The information reproducing apparatus according to claim 1, further comprising a replay control section which causes the reproducing section to reproduce an object in the second content from an object starting position,
wherein the replay control section sets output setting information in the reproducing section and causes the reproducing section to do reproducing, when there is an operation input indicating a decision after the comment has been output.

3. The information reproducing apparatus according to claim 1, wherein the reproducing section maintains the present playback state, when there is no operation input for a specific time in a state where the comment has been output.

4. The information reproducing apparatus according to claim 1, further comprising a replay control section which causes the reproducing section to reproduce an object in the second content from an object starting position,
wherein the replay control section reads a disk identification data file first under a directory of the disc, when a playback state staring at the object starting position of an object in the second content is set.

5. The information reproducing apparatus according to claim 1, further comprising a replay control section which causes the reproducing section to reproduce an object in the second content from an object starting position,
wherein the replay control section reads a playlist that indicates a playback sequence of the advanced contents related to the disc and sets a playback state, when a playback state staring at the object starting position of an object in the second content is set.

6. The information reproducing apparatus according to claim 1, wherein the reproducing section includes
a user interface manager which receives a user operation and gives an operation instruction to the continuation control section and the replay control section,
a data access manager which takes in data from not only the disc but also a network server and a persistent storage,
a data cache,
a presentation engine which decodes the output from the data cache, and
a navigation engine which controls the data cache and the presentation engine,
wherein the data access manager takes in contents from the network server and persistent storage according to operation information input from the user interface and the navigation engine and data cache expand the taken-in contents and the presentation engine obtains the reproduced output of the objects included in the contents.

7. An information reproducing method which has a reproducing section for reproducing contents on the basis of playback management information in order to reproduce the contents of a disc, and an output environment manager for setting a display mode of a video signal output from the reproducing section and an output mode of an audio signal on the basis of output setting information, the information reproducing method comprising:
changing the setting of the reproducing section according to the output setting information and causes the reproducing section to continue the reproduction, when any one of aspect, resolution, and audio used as the output setting information has been changed in the middle of reproducing a first content of the disc; and
outputting a comment to the effect that a replay state starts at an object starting position, when the change of any one of aspect, resolution, and audio used as the output setting information is input a specific time after the start of the reproduction of a second content of the disc.

8. The information reproducing method according to claim 7, further comprising a replay control section which causes the reproducing section to reproduce an object in the second content from an object starting position,
wherein the replay control section sets output setting information in the reproducing section and causes the reproducing section to do reproducing, when there is an operation input indicating a decision after the comment has been output.

9. The information reproducing method according to claim 7, wherein the reproducing section maintains the present playback state, when there is no operation input for a specific time in a state where the comment has been output.

10. The information reproducing method to claim 7, a disk identification data file under a directory of the disc is read first, when a playback state staring at the object starting position of an object in the second content is set.

11. The information reproducing method according to claim 7, wherein a playlist that indicates a playback sequence of the advanced contents related to the disc is read and a playback state is set, when a playback state staring at the object starting position of an object in the second content is set.

12. The information reproducing method according to claim 7, wherein the reproducing section includes a user interface manager, a data access manager, a data cache, a presentation engine, and a navigation engine,
wherein the data access manager takes in contents from the network server and persistent storage according to operation information input from the user interface and the navigation engine and data cache expand the taken-in contents and the presentation engine obtains the reproduced output of the objects included in the contents.
